(19) United States
(12) Patent Application Publication
(10) Pub. No.: US 2011/0311200 A1
(43) Pub. Date: Dec. 22, 2011

(54) INFORMATION PROCESSING APPARATUS, INFORMATION PROCESSING METHOD, AND PROGRAM

(75) Inventor: Atsushi MAE, Kanagawa (JP)

(73) Assignee: Sony Corporation, Tokyo (JP)

(21) Appl. No.: 13/088,643

(22) Filed: Apr. 18, 2011

(30) Foreign Application Priority Data
Jun. 17, 2010 (JP) 2010-137793

(51) Int. Cl. H04N 9/80

(52) U.S. Cl. 386/248; 386/E05.001

(57) ABSTRACT

An information processing apparatus includes a content management unit which manages a plurality of content pieces stored in a recording medium in any of a plurality of recording formats, and a control unit that controls to change a recording format of each content piece to be managed so that each content piece is managed in a recording format other than a recording format that manages each content piece stored in the recording medium when a specific operation is performed or when a given condition is satisfied.

### BACKGROUND OF THE INVENTION

1. Field of the Invention

The present invention relates to an information processing apparatus, and particularly, an information processing apparatus and an information processing method for managing contents and a program for causing a computer to execute the method.

2. Description of the Related Art

In recent years, imaging devices such as digital still cameras, digital video cameras (for example, camera-integrated type recorders), and the like for capturing a subject including people, animals, or the like to generate image data and recording the image data as image content have become widespread. In addition, for image content recorded as such, an information processing apparatus for managing content in a content management format (recording format) of an AVCHD type, or the like has been suggested.

Most of such content management formats are set with an upper limit to the amount of content that can be managed. For example, the upper limit of an AVCHD-type content management format to the number of streams to be managed is set to 4000. In addition, in many cases for content management formats, one content management format is determined in the initialization of a medium. For this reason, when the amount of content that can be managed in a content management format selected in the initialization of a medium (recording medium) reaches the upper limit thereof, it is problematic in that new content is not able to be registered thereafter.

Thus, an information processing apparatus that can manage content by two or more kinds of content management formats has been suggested. For example, a recording device has been suggested that is configured such that, when image content is managed in one content management format and the amount of image content reaches the upper limit thereof, the format is switched to another content management format (for example, refer to Japanese Unexamined Patent Application Publication No. 2007-295070 (FIG. 7)). In the recording device, for example, when the amount of image content managed in one content management format reaches the upper limit thereof, image content added thereafter is managed in another content management format.

### SUMMARY OF THE INVENTION

In the above-described related art, when the amount of image content reaches the upper limit of the content management format, the format is switched to another content management format, and image content added thereafter can be managed therein.

However, management in one content management format according to the capacity of a recording medium, the set amount of content, or the like may be preferable to the use of a plurality of management systems at the same time. For example, when content is backed up, it is preferable to perform management in one content management format with a higher upper limit. Thus, if a format can be easily switched to an appropriate content management format according to, for example, the capacity of a recording medium, the set amount of content, or the like, it is considered that the recording medium can be used more effectively.

The present invention takes the above circumstance into consideration, and it is desirable that, when a plurality of management systems is present, a format is easily switched to a proper management system.

According to an embodiment of the invention, there is provided an information processing apparatus, an information processing method, and a program that causes a computer to execute the method, including a content management unit which manages a plurality of content pieces stored in a recording medium in any of a plurality of recording formats, and a control unit that controls to change a recording format of each content piece to be managed so that each content piece is managed in a recording format other than a recording format that manages each content piece stored in the recording medium when a specific operation is performed or when a given condition is satisfied. Accordingly, when a specific operation is performed or when a given condition is satisfied, the invention has an effect that a recording format of each content piece to be managed is changed so that each content piece is managed in a recording format other than a recording format that manages each content piece stored in the recording medium.

In addition, according to the embodiment of the invention, the given condition may be a condition specified by the relationship between information regarding recording capacity of the recording medium and the number of a plurality of content pieces that is the recording target of the recording medium, and the control unit may control the changes so that each content piece is managed in a specific recording format when the relationship between information regarding recording capacity of the recording medium and the number of a plurality of content pieces that are the recording target of the recording medium satisfies the given condition. Accordingly, when the relationship between the information regarding the recording capacity of a recording medium and the number of a plurality of content pieces that are the recording target of the recording medium satisfies a given condition, the invention has an effect to perform a change so that each content piece is managed in a specific recording format.

In addition, according to the embodiment of the invention, the plurality of recording formats may be recording formats of which the upper limits for content to be managed are different from each other, the specific recording format may be a recording format of which compatibility regarding play-back using devices other than the information processing apparatus is low, and which has a larger number of content pieces to be managed than has another recording format, and the recording format other than the specific recording format may be a recording format of which compatibility regarding play-back using devices other than the information processing apparatus is high, and which has a smaller number of content pieces to be managed than has the specific recording format. Accordingly, when a given condition is satisfied, the invention has an effect that a format can be changed to a recording format having a large number of content pieces to be managed.

In addition, according to the embodiment of the invention, an interface for connecting the recording medium is included, the given condition may be a condition specified by a connection method of the recording medium via the interface, and the control unit may control to perform the change so that each content piece is managed in a specific recording format when the connection method of the recording medium via the interface satisfies the given condition. Accordingly, when a connection method of a recording medium via an interface satisfies a given condition, the invention has an effect of performing a change such that each content piece is managed in a specific recording format.

In addition, according to the embodiment of the invention, when a recording format of each content piece to be managed is changed, the control unit may control such that an actual data file and attribute information regarding the actual data file among content managed in the recording format before the change are paired, and the pair of the actual data file and the attribute information is subjected to a transfer process so as to manage the pair of the actual data file and the attribute information in the other recording format. Accordingly, when a recording format of each content piece to be managed is changed, the invention has an effect that a transfer process of a pair of an actual data file and attribute information is performed so that the pair of an actual data file and attribute information is managed in another recording format.

In addition, according to the embodiment of the invention, when a recording format of each content piece to be managed is changed, the control unit may control to perform a transfer process of attribute information regarding an actual data file among content managed by the recording format before the change so that the attribute information is managed in the other recording format. Accordingly, when a recording format of each content piece to be managed is changed, the invention has an effect that a transfer process of attribute information is performed so that the attribute information regarding an actual data file is managed by another recording format.

In addition, according to the embodiment of the invention, the content management unit may manage content added after the change is performed in the other recording format. Accordingly, the invention has an effect that content added after a change is performed is managed by a recording format after the change.

In addition, according to another embodiment of the invention, there is provided an information processing apparatus, an information processing method, and a program that causes a computer to execute the method, including an interface for connecting a recording medium, a content management unit that manages a plurality of content pieces stored in the recording medium in any of a plurality of recording formats, and a control unit that controls to perform an initialization process by determining a recording format of each content piece to be managed so that each content piece stored in the recording medium is managed in a specific recording format when a connection method of the recording medium via the interface satisfies a given condition. Accordingly, when a connection method of a recording medium via the interface satisfies a given condition, the invention has an effect that a recording format of each content piece to be managed is determined and an initialization process thereof is performed so that each content piece stored in the recording medium is managed by a specific recording format.

According to the invention, when a plurality of management systems is present, the effect that a format is easily switched to a proper management system can be excellently exhibited.

### BRIEF DESCRIPTION OF THE DRAWINGS

FIGS. 1A and 1B are diagrams briefly showing connection methods of an imaging device and a recording medium according to a first embodiment of the invention;

FIG. 2 is a block diagram showing an example of a functional composition of the imaging device according to the first embodiment of the invention;

FIGS. 3A and 3B are diagrams showing an example of file compositions of image content stored in the recording medium according to the first embodiment of the invention;

FIG. 4 is a diagram schematically showing management systems of content management formats for managing image content stored in the recording medium according to the first embodiment of the invention;

FIGS. 5A and 5B are diagrams showing examples of operation screens used when a management system is changed by a recording control unit according to the first embodiment of the invention;

FIGS. 6A and 6B are diagrams schematically showing the flows of data when the recording control unit changes a content management system (change from a management system A to B) according to the first embodiment of the invention;

FIGS. 7A and 7B are diagrams schematically showing the flows of data when the recording control unit changes the content management system (change from a management system A to B) according to the first embodiment of the invention;

FIGS. 8A and 8B are diagrams schematically showing the flows of data when the recording control unit changes the content management system (change from a management system B to A) according to the first embodiment of the invention;

FIGS. 9A and 9B are diagrams schematically showing the flows of data when the recording control unit changes the content management system (change from a management system B to A) according to the first embodiment of the invention;

FIG. 10 is a flowchart showing an example of the processing procedure of a content management system change process by the imaging device according to the first embodiment of the invention;

FIG. 11 is a flowchart showing an example of the processing procedure of the content management system change process by the imaging device according to the first embodiment of the invention;

FIG. 12 is a flowchart showing an example of a change process to the management system A in the processing procedure of the content management system change process by the imaging device according to the first embodiment of the invention;

FIG. 13 is a flowchart showing an example of a change process to the management system B in the processing procedure of the content management system change process by the imaging device according to the first embodiment of the invention;

FIG. 14 is a diagram showing an example of an operation screen used when a management system is to be selected in the initialization of a recording medium by the recording control unit according to the first embodiment of the invention;

FIG. 15 is a flowchart showing an example of the processing procedure of the initialization process of a content management system by the imaging device according to the first embodiment of the invention;

FIGS. 16A and 16B are diagrams showing an example of the file composition and management system of image content stored in a recording medium according to a second embodiment of the invention;

FIG. 17 is a flowchart showing an example of the processing procedure of a content management system change process by the imaging device according to the second embodiment of the invention;

FIG. 18 is a flowchart showing an example of the processing procedure of a content management system change process by the imaging device according to the second embodiment of the invention;

FIG. 19 is a diagram showing an example of the file composition of image content stored in the recording medium according to a third embodiment of the invention;

FIG. 20 is a diagram showing an example of the file composition of image content stored in the recording medium according to the third embodiment of the invention;

FIG. 21 is a diagram showing an example of a management system of image content stored in the recording medium according to the third embodiment of the invention;

FIG. 22 is a flowchart showing an example of the processing procedure of a content management system change process by the imaging device according to the third embodiment of the invention; and

FIG. 23 is a flowchart showing an example of the processing procedure of a content management system change process by the imaging device according to the third embodiment of the invention.

### DESCRIPTION OF THE PREFERRED EMBODIMENTS

Hereinafter, embodiments for implementing the invention (hereinbelow, referred to as “embodiments”) will be described. Description will be provided in the following order.
1. First Embodiment (content management control: an example of changing a management target of content that can be managed in a recording format of two management systems)
2. Second Embodiment (content management control: an example of changing a management target of content and metadata that can be managed in a recording format of two management systems)
3. Third Embodiment (content management control: an example of changing a management target of content and metadata that can be managed in a recording format of two management systems)

### 1. First Embodiment

### Example of Recording Medium Connection

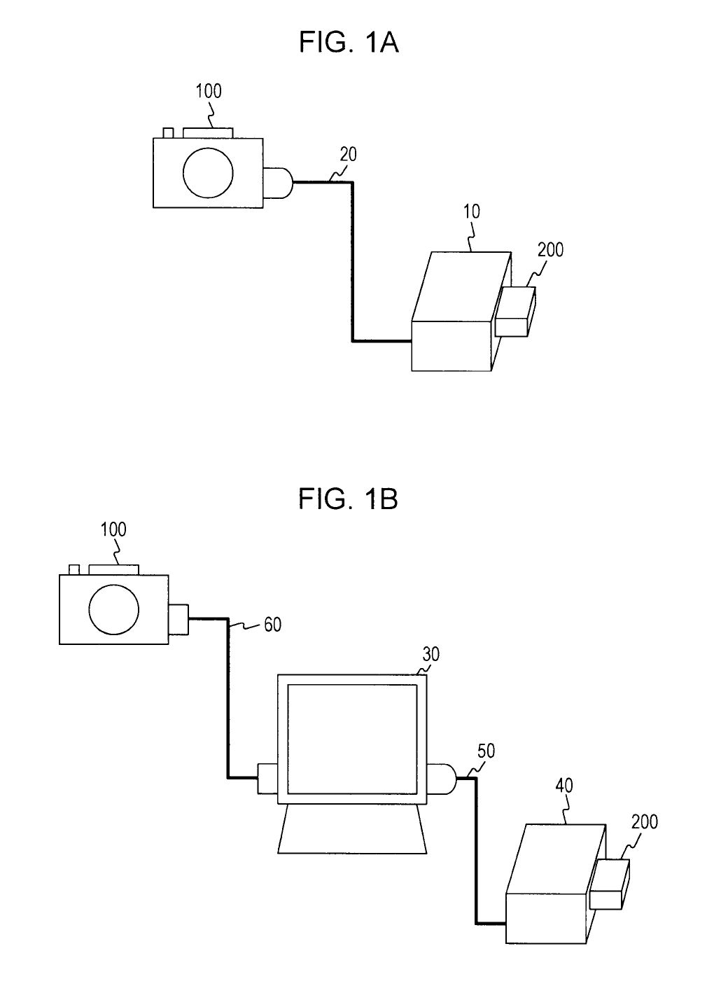

FIGS. 1A and 1B are diagrams briefly showing connection methods of an imaging device 100 and a recording medium 200 according to a first embodiment of the invention. The imaging device 100 is a digital still camera that can generate image data (captured image) by, for example, capturing a subject and recording the image data as an image file. The recording medium 200 is a recording medium (media) that stores the image file (image content (still image content or moving image content)) recorded by the imaging device 100. FIGS. 1A and 1B show examples in which memory cards are used as the recording medium 200.

FIG. 1A shows an example in which the imaging device 100 and the recording medium 200 are in a USB (Universal Serial Bus) connection. To be more specific, the recording medium 200 is loaded on a memory card reader-writer 10 connected to the imaging device 100 via a USB cable 20, thereby connecting the imaging device 100 and the recording medium 200. In addition, the USB cable 20 is an example of an inter-device interface.

FIG. 1B shows an example of a state of network connection between the imaging device 100 and the recording medium 200. To be more specific, the recording medium 200 is loaded on a memory card reader-writer 40 that is connected to the imaging device 100 via a personal computer 30, thereby connecting the imaging device 100 and the recording medium 200. In addition, the personal computer 30 and the imaging device 100 are connected via a LAN (Local Area Network) cable 60. In addition, the imaging device 100 and the recording medium 200 are connected to a USB cable 50.

### [Composition Example of Imaging Device]

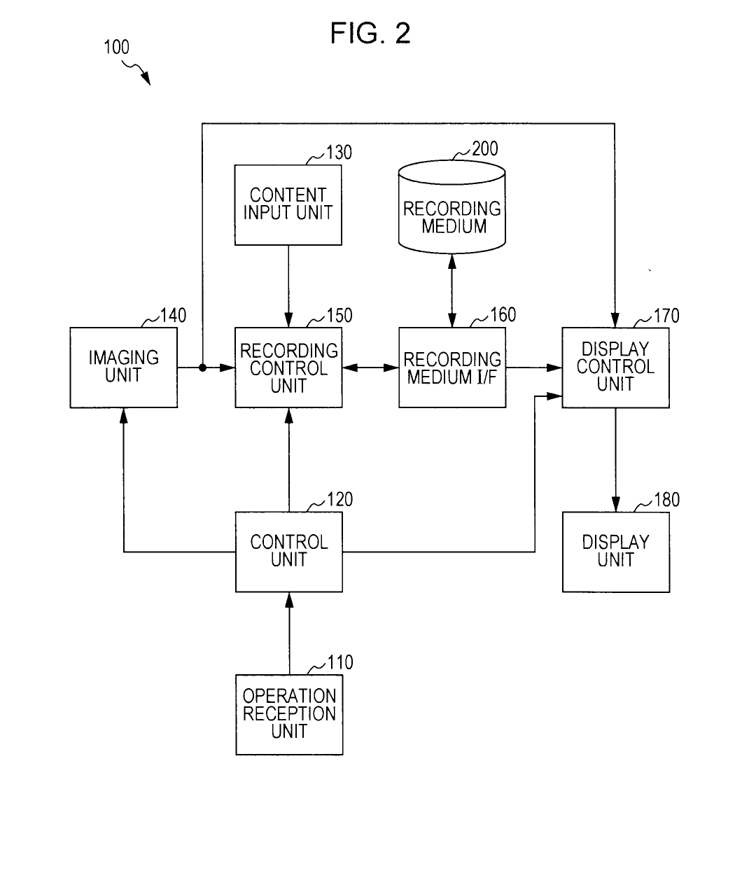

FIG. 2 is a block diagram showing an example of a functional composition of the imaging device 100 according to the first embodiment of the invention. The imaging device 100 includes an operation reception unit 110, a control unit 120, a content input unit 130, an imaging unit 140, a recording control unit 150, a recording medium I/F (interface) 160, a display control unit 170, and a display unit 180.

The operation reception unit 110 is a unit for receiving details of an operation by a user, and supplies an operation signal according to the received operation details to the control unit 120. The operation reception unit 110 corresponds to, for example, an operation member such as a shutter button or a touch panel. The touch panel is arranged, for example, over the display unit 180 so that the operation transmits the screen of the display unit 180, and receives an operation input from a user by detecting an object coming into contact with the display surface. In other words, when users press a desired position on the display surface in the display unit 180 by touching with their fingers or the like, the touch panel detects a coordinate of the pressed position and outputs an operation signal corresponding to the detected coordinate to the control unit 120. Then, when the operation signal is acquired, the control unit 120 executes a predetermined process based on the acquired operation signal. As the operation reception unit 110, for example, a touch panel that converts the contact on the display surface to an electric signal using a dedicated sensor and outputs the converted electric signal to the control unit 120 can be used. In addition, as the operation reception unit 110, for example, an optical sensor type touch panel that can detect an object approaching or contacting with the display surface (for example, a finger of a user) may be used.

The control unit 120 controls each unit of the imaging device 100 based on the operation details from the operation reception unit 110. When, for example, a specific operation is performed or when a given condition is satisfied, the control unit 120 controls to change a content management format (recording format) of each content that is the management target stored in the recording medium 200. In other words, the control unit 120 controls to change a content management format of each content piece that is the management target so that the content is to be managed in a content management format other than the current content management format.

To be more specific, when a content management format of each content piece that is the management target is to be changed, an actual data file and attribute information relating thereto among content managed in the content management format before the change are paired. Then, the control unit 120 controls to perform a transfer process of the pair of the actual data file and the attribute information so that the pair of the actual data file and the attribute information is managed in another content management format. The actual data file referred herein means a file of compressed data of moving images or still images or a file containing subordinate data (attribute information or the like) pertaining to the compressed data. In addition, the given condition can be, for example, a condition specified by the relationship between information regarding the recording capacity of the recording medium 200 (for example, total capacity or free capacity) and the number of a plurality of content pieces to be stored in the recording medium 200. In addition, a given condition can be a condition specified by a connection method to the recording medium 200 via the recording medium I/F 160.

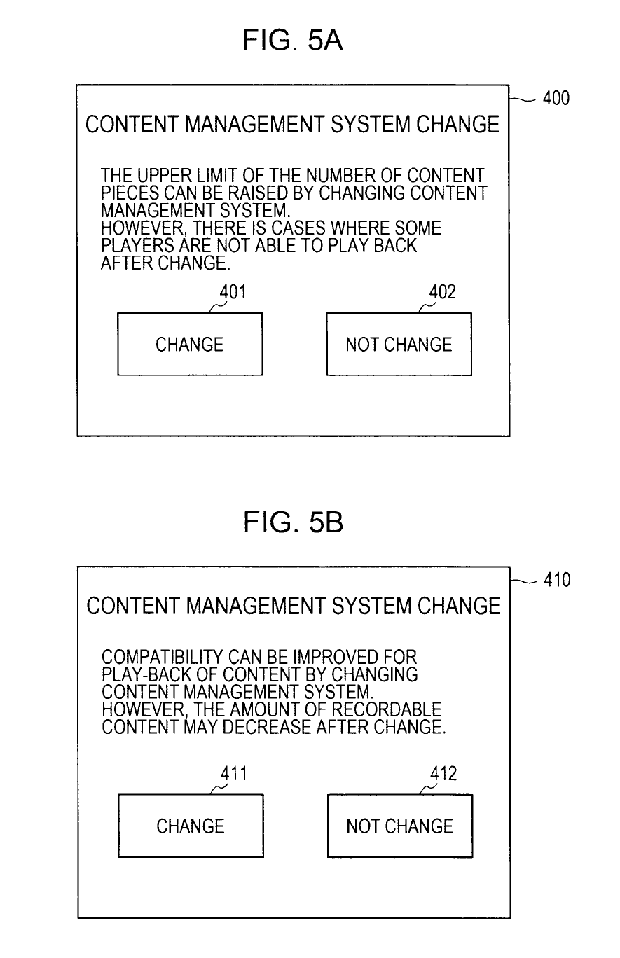

Furthermore, for example, when the connection method to the recording medium 200 via the recording medium I/F 160 satisfies a given condition, the control unit 120 controls to determine a content management format to perform an initialization process. In other words, the control unit 120 controls to determine a content management format of each content piece that is the management target and perform the initialization process so that each piece of content stored in the recording medium 200 is managed in a specific content management format. The details of the control will be described in detail with reference to FIGS. 5A to 9B.

The content input unit 130 inputs content (moving image content or the like) that is output from an external device and supplies the content to the recording control unit 150.

The imaging unit 140 captures a subject and generates captured images based on the control of the control unit 120 and supplies the generated captured images to the recording control unit 150. For example, when the operation reception unit 110 receives an instruction operation for recording a moving image (for example, a press operation of a recording button), the imaging unit 140 sequentially generates captured images (frames) at a predetermined frame rate. To be more specific, the imaging unit 140 includes an imaging element for converting light of a subject incident through a lens to an electric signal and a signal processing part that generates a digital image signal (image data) by processing an output signal of the imaging element. In other words, an optical image of a subject incident through a lens forms an image on the imaging face of an imaging element in the imaging unit 140, the imaging element performs an imaging operation in this state, and the signal processing part performs a signal processing for the imaging signal, thereby generating a digital imaging signal. Then, various image processes such as color/grayscale processes including an interpolation process, white balance, or the like are performed for the generated image signal (digital image signal) to generate image data (captured image) to be recorded. Furthermore, as the imaging element, for example, a CCD (Charge Coupled Device) or a CMOS (Complementary Metal Oxide Semiconductor) can be used.

The recording control unit 150 records the captured image output from the imaging unit 140 in the recording medium 200 as an image file (image content) based on the control of the control unit 120. For example, when the operation reception unit 110 receives an instruction operation for recording a moving image, the recording control unit 150 records the captured image output from the imaging unit 140 at a predetermined frame rate in the recording medium 200 as a moving image file (moving image content). Furthermore, the instruction operation for recording the moving image is performed, for example, by a press operation of a recording button. In addition, the recording control unit 150 records the content output from the content input unit 130 in the recording medium 200 based on the control of the control unit 120.

In addition, the recording control unit 150 manages a plurality of content pieces stored in the recording medium 200 in any of a plurality of content management formats (recording formats) based on the control of the control unit 120. Furthermore, for example, when a specific operation is performed or when a given condition is satisfied, the recording control unit 150 changes the content management format (recording format) of each content piece that is the management target stored in the recording medium 200 based on the control of the control unit 120. In addition, for example, the recording control unit 150 manages content added after the change in a changed content management format. Moreover, for example, when the connection method with the recording medium 200 via the recording medium I/F 160 satisfies a given condition, the recording control unit 150 determines a content management format and performs an initialization process based on the control of the control unit 120. Each of the processes will be described in detail with reference to FIGS. 5A to 9B. Furthermore, the recording control unit 150 is an example of the content management unit described in the claims.

The recording medium I/F 160 is an interface for connecting to the recording medium 200 and sending and receiving various image data and other information between the recording medium 200. Furthermore, the recording medium I/F 160 is an example of the interface described in the claims.

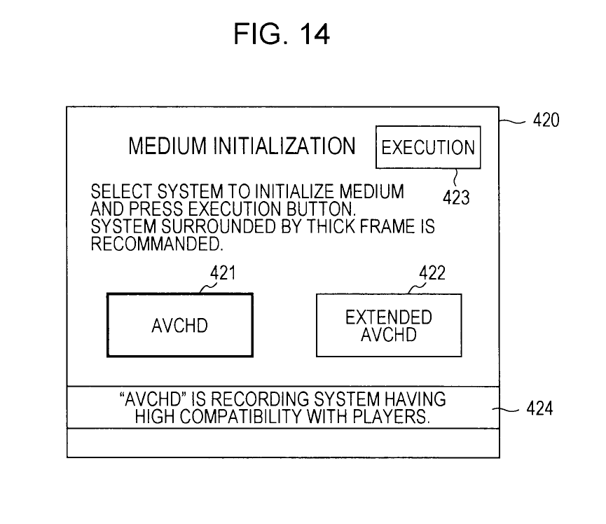

The display control unit 170 causes the display unit 180 to display image content stored in the recording medium 200 and image content generated by the imaging unit 140 based on the control of the control unit 120. In addition, for example, the display control unit 170 causes the display unit 180 to display various screens (for example, change necessity confirmation screens 400 and 410 shown in FIGS. 5A and 5B and a recommended management system notification screen 420 shown in FIG. 14) or monitoring images (so-called through images).

The display unit 180 is a display unit for displaying various images based on the control of the display control unit 170. As the display unit 180, for example, LCDs (Liquid Crystal Displays), organic EL (Electro Luminescence) panels, or the like can be used.

The recording medium 200 stores the image data (captured image) generated by the imaging unit 140 as an image file (image content (still image content or moving image content)) based on the control of the recording control unit 150. In addition, the recording medium 200 stores the content input from the content input unit 130 based on the control of the recording control unit 150. Furthermore, the recording medium 200 supplies the stored image content in the display control unit 170. To be more specific, the recording medium 200 stores content managed by either of two content management formats with different upper limits for the number of content pieces that can be managed.

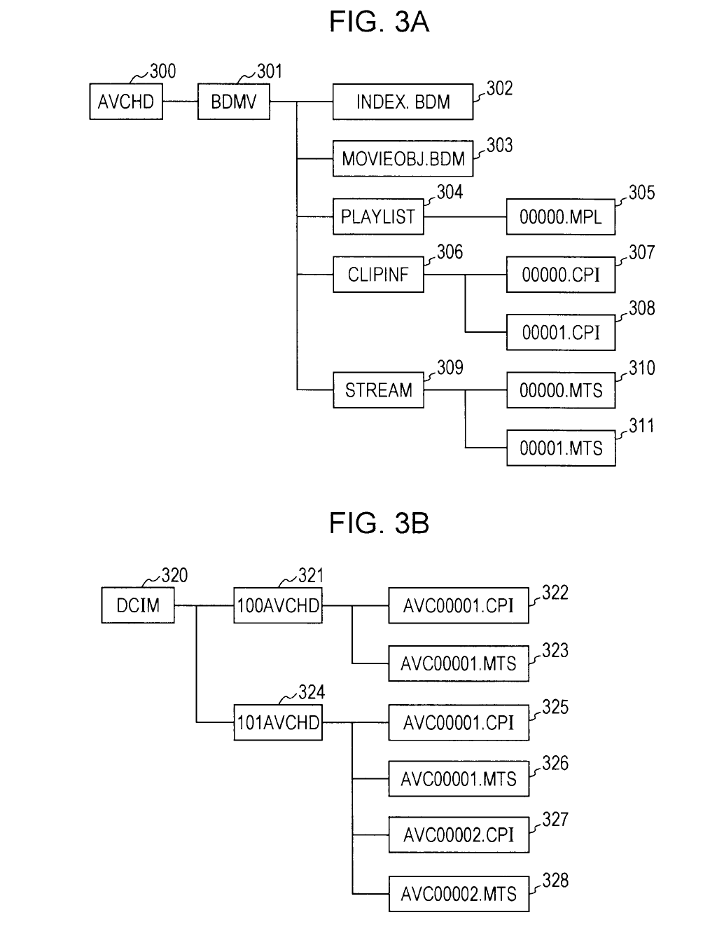

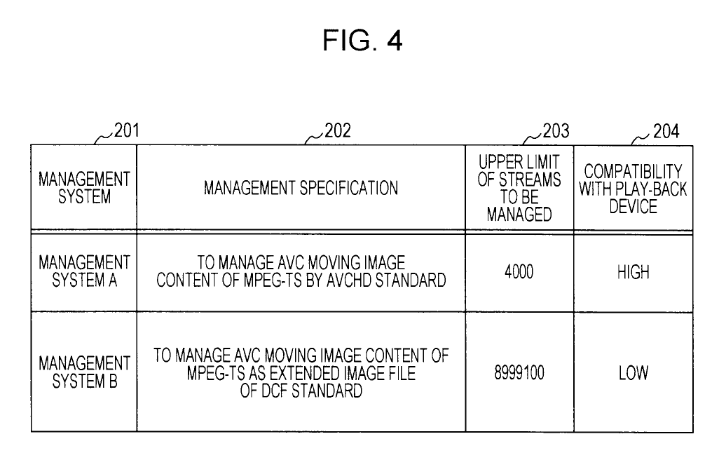

Furthermore, as the recording medium 200, for example, one or a plurality of recording media that is removable including discs such as DVDs (Digital Versatile Discs), semiconductor memories such as memory cards, or the like can be used. In addition, such recording media may be built into the imaging device 100, and may be detachable from the imaging device 100 as shown in FIGS. 1A and 1B. Furthermore, the file composition of the content stored in the recording medium 200 will be described in detail with reference to FIGS. 3A to 4.

### [Data Structure Example of Content Management Format and Management System Example]

FIGS. 3A and 3B are diagrams showing an example of file compositions of image content stored in the recording medium 200 according to the first embodiment of the invention. The example of FIGS. 3A and 3B shows an example in which the image content managed in two content management formats (management system A and management system B) with different upper limits for the number of content pieces that can be managed is stored in one recording medium. Furthermore, FIG. 3A shows an example of the file composition of image content managed by the management system A. In addition, FIG. 3B shows an example of the file composition of image content managed by the management system B. Furthermore, the file compositions shown in FIGS. 3A and 3B will be described in detail with reference to FIG. 4.

FIG. 4 is a diagram schematically showing management systems of content management formats for managing image content stored in the recording medium 200 according to the first embodiment of the invention. FIG. 4 illustrates an example of the management system A (shown in FIG. 3A) and the management system B (shown in FIG. 3B) as a management system 201 of a content management format for managing the image content stored in the recording medium 200.

The management system A is a content management format conforming to the AVCHD standard as shown in a management specification 202. To be more specific, the management system A is for managing AVC moving image content in MPEG (Moving Picture Experts Group)-TS (Transport Stream) conforming to the AVCHD standard.

The management system B is a unique content management format conforming to a DCF (Design rule for Camera File system) standard as shown in the management specification 202. Specifically, the management system B is a management system for managing AVC moving image content (AVC stream file) of MPEG-TS as an extended image file of the DCF standard by grouping the content as a DCF object. In the same manner, the management system B is a management system operated such that clip information files of the AVCHD standard as other DCF files are grouped as a DCF object. Furthermore, the management system A and the management system B are mutually convertible.

In addition, an upper limit of streams to be managed 203 is “4000” for the management system A, but “8999100” for the management system B. Moreover, compatibility with play-back devices 204 is “high” for the management system A, but “low” for the management system B.

As such, the management system A has characteristics of a low upper limit of streams to be managed, but high play-back compatibility with play-back devices (players). On the other hand, the management system B has characteristics of a high upper limit of streams to be managed, but low play-back compatibility with play-back devices.

For this reason, it is preferable to manage image content with a high possibility of being played back by a user by the management system A. However, since the management system A has a lower upper limit of streams to be managed than the management system B, it is supposed that the entire image content is not able to be managed by the management system A. Thus, in the first embodiment of the invention, the management system is appropriately changed to manage content stored in the recording medium 200 according to the state of using the recording medium 200, or the like.

Next, the file composition of image content managed by the management systems A and B will be described with reference to FIGS. 3A and 3B.

Under the root directory of the recording medium 200, there are arranged at least one of a directory “AVCHD” 300 as shown in FIG. 3A and a directory “DCIM” 320 as shown in FIG. 3B. In addition, under the directory “AVCHD” 300, a directory “BDMV” 301 is arranged.

The directory “BDMV” 301 shown in FIG. 3A is a directory to which folders and files defined as a moving image video recording application format belong.

Under the directory “BDMV” 301, a file “INDEX.BDM” 302 and a file “MOVIEOBJ.BDM” 303 are arranged. In addition, under the directory “BDMV” 301, a directory “PLAYLIST” 304, a directory “CLIPINF” 306, and a directory “STREAM” 309 are arranged.

The file “INDEX.BDM” 302 is an index file that accommodates the contents of the directory “BDMV” 301, and is a file that is registered with and manages moving image files (chapters). In addition, the file “MOVIEOBJ.BDM” 303 is a file determined in an application recording format, and accommodates information of movie objects.

The directory “PLAYLIST” 304 is a directory in which the database of a playlist is arranged. The directory “PLAYLIST” 304 includes, for example, files regarding the playlist (for example, a file “00000.MPL” 305). Furthermore, the file name of files in the directory “PLAYLIST” 304 is composed of five-digit numbers and an extension. In addition, “.MPL” is used as the extension of the file. Furthermore, a file in the directory “PLAYLIST” 304 is a unit for registering access of each content piece to moving image files (chapters), and the starting point (IN point) and the ending point (OUT point) thereof are managed by designating a logical time.

The directory “CLIPINF” 306 is a directory in which the database of clips is placed. The directory “CLIPINF” 306 includes clip information files (for example, files “00000.CPI” 307 and “00001.CPI” 308) for each of the clip AV stream files. Furthermore, the file name of files in the directory “CLIPINF” 306 is composed of five-digit numbers and an extension. “.CPI” is used as the extension of the files. Moreover, a file in the directory “CLIPINF” 306 is a file for managing access to AV streams corresponding to moving image files (chapters).

The directory “STREAM” 309 is a directory in which AV stream files as actual substances are placed. The directory “STREAM” 309 includes, for example, clip AV stream files (for example, files “00000.MTS” 310 and “00001.MTS” 311) corresponding to each of the clip information files. In addition, a file in the directory “STREAM” 309 is composed of a transport stream of MPEG-2, and the file name is composed of five-digit numbers and an extension. Herein, the portion of five-digit numbers in a file name shows the corresponding relationship between clip information files and clip AV stream files by making the portion equal to that of the corresponding clip information files. In addition, “.MTS” is used as the extension of each file. Furthermore, as a file in the directory “STREAM” 309, one chapter is assumed to be one file.

The directory “DCIM” 320 is a directory to which folders or still image files defined in a still image recording application format belong. In addition, under the directory “DCIM” 320, DCF directories (for example, a directory “100AVCHD” 321 and a directory “101AVCHD” 324) are arranged. Furthermore, under the DCF directories, DCF files (files “AVC00001.CPI” 322, “AVC00001.MTS” 323, “AVC00001.CPI” 325, “AVC00001.MTS” 326, or the like) are arranged.

The file “AVC00001.CPI” 322 is a DCF file obtained by making a clip information file of AVCHD standard into a DCF object. In addition, the same is applied to files “AVC00001.CPI” 325 and “AVC00002.CPI” 327.

The “AVC00001.MTS” 323 is a DCF file obtained by making AVC moving image content (AVC stream file) of MPEG-TS as an extended image file of DCF standard into a DCF object. In addition, the same is applied to files “AVC00001.MTS” 326 and “AVC00002.MTS” 328.

In addition, in the management system B, one piece of content is managed after being grouped by setting each of the files (for example, the files “AVC00001.CPI” 322 and “AVC00001.MTS” 323) as a DCF object.

Herein, in the first embodiment of the invention, it is assumed that each piece of content stored in the recording medium 200 is managed by either of the management systems A or B. For example, a case where each content piece stored in the recording medium 200 is managed by the management system A is assumed. In this case, since the management system A has a low upper limit of streams to be managed as described above, it is assumed that additional content is not able to be recorded therein. In addition, even when a recording time of each content piece is short, and when the number of streams to be managed reaches the upper limit even though there is remaining storage capacity in the recording medium 200, it is assumed that additional content is not able to be recorded therein. Thus, in such a case, the management system is appropriately changed to manage content stored in the recording medium 200 according to the state of using the recording medium 200, or the like.

### [Example of Change Operation of Management System]

FIGS. 5A and 5B are diagrams showing examples of operation screens used when a management system is changed by the recording control unit 150 according to the first embodiment of the invention. FIG. 5A shows an example of an operation screen (change necessity confirmation screen 400) displayed on the display unit 180 when an operation of instructing a change from the management system A to the management system B is performed. FIG. 5B shows an example of an operation screen (change necessity confirmation screen 410) displayed on the display unit 180 when an operation of instructing a change from the management system B to the management system A is performed. The change necessity confirmation screens 400 and 410 are displayed on the display unit 180 by the display control unit 170 when a given condition is satisfied. The given condition is a determination condition used when a management system is to be changed (switched), and for example, can be an individual or a combined condition of the following (1) to (6).
(1) Capacity of a recording medium (for example, the total capacity or free capacity)
(2) Type of a recording medium (for example, a memory disk, an HDD)
(3) Management system currently applied (content management format)
(4) Condition according to a connection method (for example, the vendor ID, product ID, or the like in the case of USB connection)
(5) Number to be managed such as the number of content pieces currently managed or the like (as other kinds of the number to be managed, for example, the number of titles, or the number of files can be used)
(6) Number of content pieces to be newly added by means of copying or the like

The change necessity confirmation screen 400 is provided with a “change” button 401 and a “not change” button 402. The “change” button 401 and the “not change” button 402 are buttons to be pressed when the management system of content stored in the recording medium 200 is to be changed from the management system A to the management system B by a user's operation.

The change necessity confirmation screen 410 is provided with a “change” button 411 and a “not change” button 412. The “change” button 411 and the “not change” button 412 are buttons to be pressed when the management system of content stored in the recording medium 200 is to be changed from the management system B to the management system A by a user's operation.

As such, when a change operation (specific operation) for a management system of content is to be performed, the control unit 120 outputs a control signal to the recording control unit 150 according to the change operation. When the control signal is received, the recording control unit 150 performs a management system change process where a management system of content stored in the recording medium 200 is changed.

Furthermore, this example shows that, when the above-described given condition is satisfied, the display control unit 170 causes the display unit 180 to display the change necessity confirmation screen 400 or 410, and the management system is changed on the condition of a change instruction by a user. However, the change of the management system may be automatically performed without a user's operation. In this case, the fact that an automatic change in the management system is to be performed is displayed on the display unit 180 and notified to a user.

### [Modified Example of Management System]

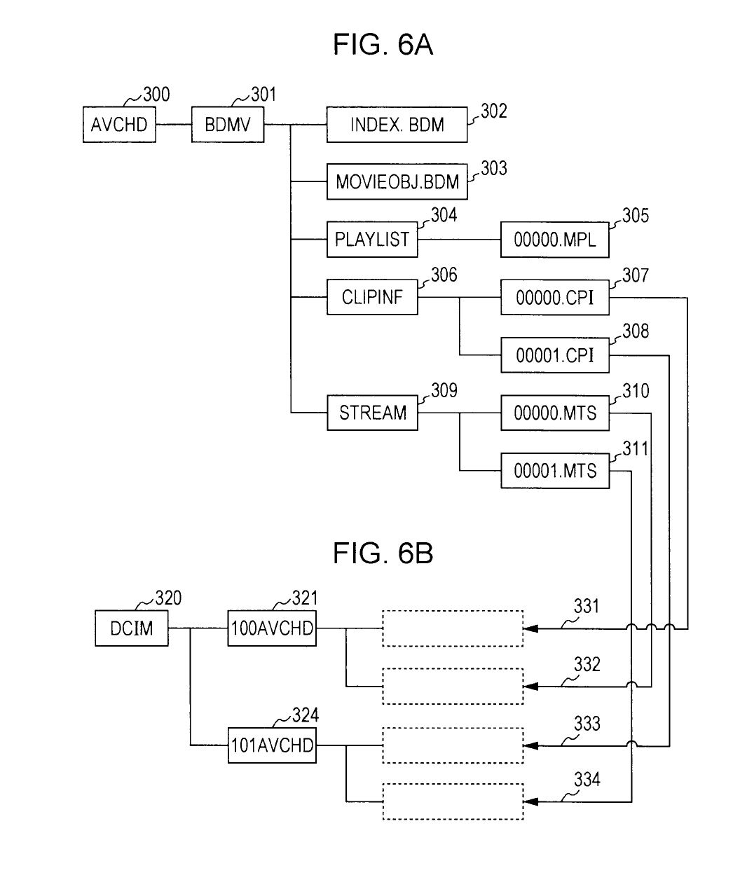

FIGS. 6A to 9B are diagrams schematically showing flows of data when the recording control unit 150 changes a content management system according to the first embodiment of the invention. Furthermore, in the examples shown in FIGS. 6A to 9B, a case where content that is the management target of the management systems A and B is relatively small will be exemplified for the sake of convenience of description.

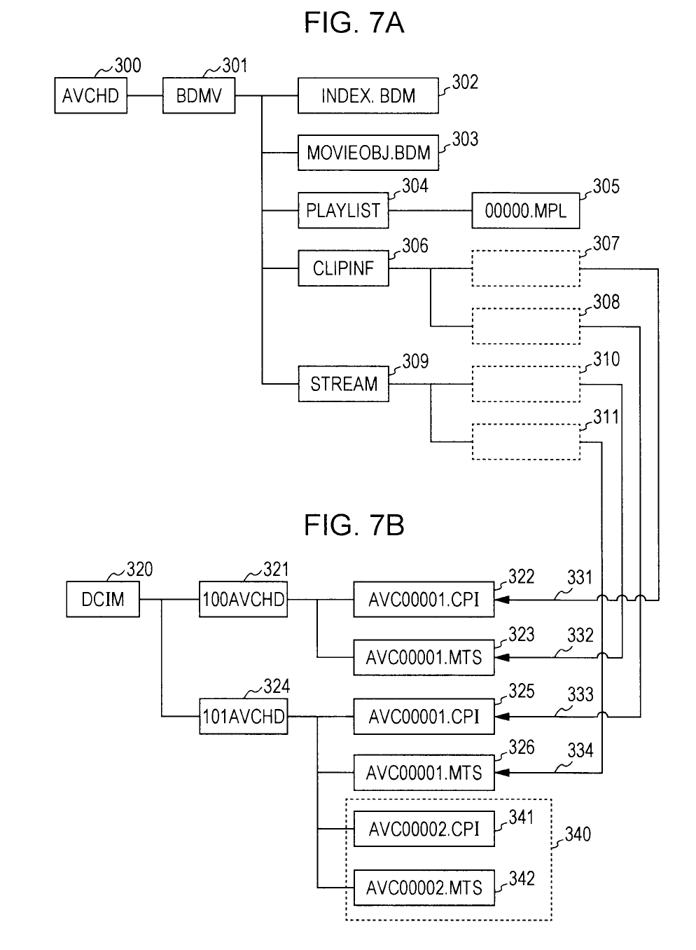

FIGS. 6A to 7B schematically show flows of data when the management system of image content is to be changed when the “change” button 401 is pressed on the change necessity confirmation screen 400 shown in FIG. 5A. In other words, the drawings show flows of data when the management system is changed from the management system A to the management system B.

When the management system is changed from the management system A to the management system B, the number of content pieces stored in the recording medium 200 and free capacity of the recording medium 200 are acquired. Then, it is determined whether or not the free capacity of the recording medium 200 is sufficiently adequate. Specifically, it is determined whether or not a necessary capacity is sufficient by adding data sizes of file entries or directory entries of a file system. Generally, if the capacity is relatively small, the free capacity is determined to be sufficiently adequate. Furthermore, when the free capacity of the recording medium 200 is not sufficiently adequate, an error screen is displayed on the display unit 180, and an error processing is performed.

In addition, when the free capacity of the recording medium 200 is sufficiently adequate, the DCF directory is created. Furthermore, the creation of the DCF directory is performed depending on the necessity during a transfer process. Specifically, cases where a new DCF directory is necessary to be created is when a DCF directory is not present or when 9999 DCF objects have been recorded in a directory with the maximum DCF directory number.

Next, the AVCHD stream file and the clip information file corresponding thereto are made to be DCF objects, and each of the files made to be the DCF object is transferred under the DCF directory. In this case, MTS files and CPI files are renamed with a DCF file name with the same number and transferred. In other words, the extension thereof is maintained without change and the transfer process is performed.

For example, as shown by arrows 331 and 332 of FIGS. 6A and 6B, a transfer process is performed for a clip AV stream file and a clip information file corresponding thereto. Specifically, the transfer process is performed for a file “00000.MTS” 310 and a file “00000.CPI” 307 corresponding thereto. Then, as shown in FIG. 7B, a file “AVC00001.CPI” 322 and a file “AVC00001.MTS” 323 are recorded under a directory “100AVCHD” 321. In addition, in the same manner, as shown by arrows 333 and 334 of FIGS. 6A and 6B, a transfer process is performed for a file “00001.MTS” 311 and a file “00001.CPI” 308 corresponding thereto. Then, as shown in FIG. 7B, a file “AVC00001.CPI” 325 and a file “AVC00001.MTS” 326 are recorded under a directory “101AVCHD” 324.

The transfer process is repeatedly performed until the transfer process is completed for all stream files of the AVCHD. In other words, the transfer process is performed as many times as the number of stream files of the AVCHD. Then, when the transfer process is completed for all the stream files of the AVCHD, the AVCHD directory is deleted. In the deletion, directories and files remaining in the AVCHD directory are eliminated together.

In addition, when new content is to be added after the transfer process, each file is recorded as new content 340 under the directory “101AVCHD” 324 as shown in FIG. 7B. For example, a file “AVC00002.CPI” 341 and a file “AVC00002.MTS” 342 are recorded.

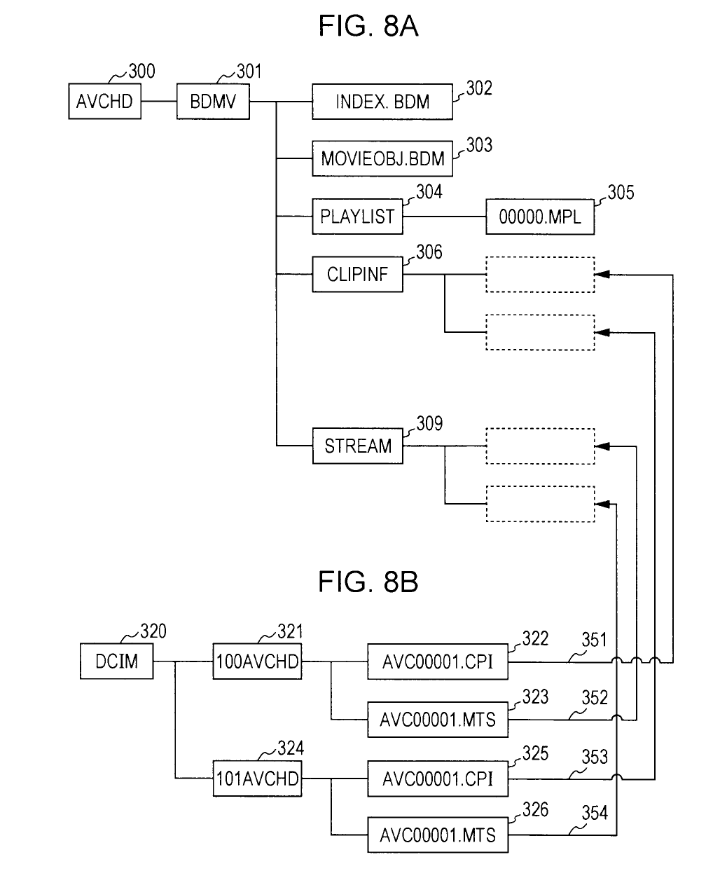

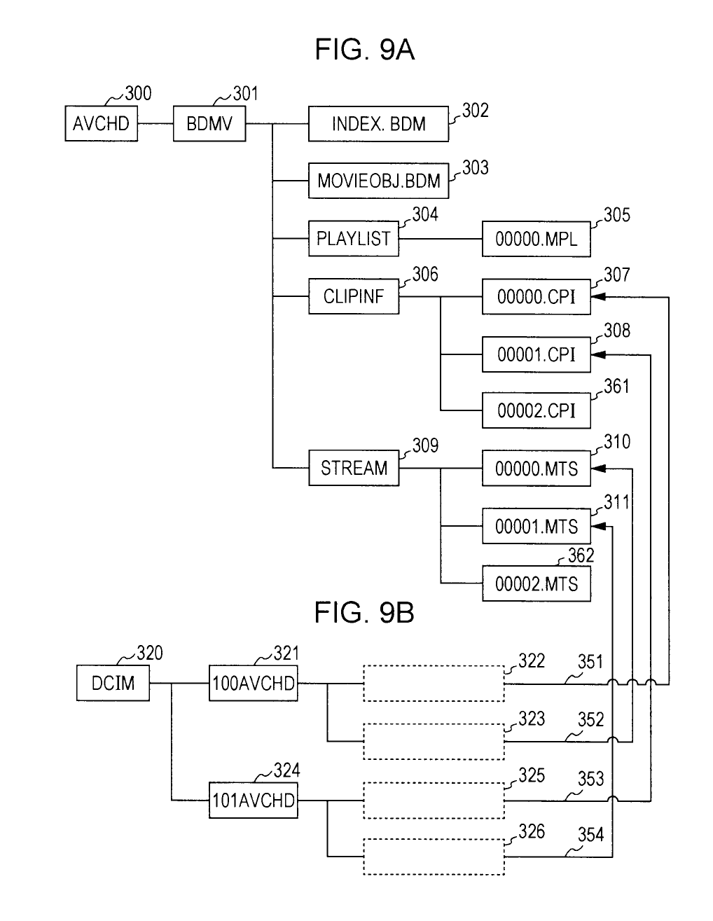

FIGS. 8A to 9B schematically show flows of data during a management system change of image content when the “change” button 411 on the change necessity confirmation screen 410 shown in FIG. 5B is pressed. In other words, the drawings show flows of data when a management system changes from the management system B to the management system A.

When a management system is to be changed from the management system B to the management system A, the number of content pieces stored in the recording medium 200 and the free capacity of the recording medium 200 are acquired. Then, it is determined whether or not the free capacity of the recording medium 200 is sufficiently adequate. Specifically, it is determined whether or not there is free capacity sufficient for storing index files and playlist files of AVCHD. For example, a free capacity of 1 KB for one chapter and a free capacity for several clusters of fixed costs are necessary. Furthermore, when the free capacity of the recording medium 200 is not sufficiently adequate, the display unit 180 displays an error screen to perform an error processing.

In addition, when the free capacity of the recording medium 200 is sufficiently adequate, the directory structure of the AVCHD standard and an index file and a movie object file without titles are created. Then, a playlist file is created. Furthermore, the creation of the playlist file is performed depending on the necessity during a transfer process. Specifically, attribute information in a clip information file (CPI) is checked, and if a condition that the playlist file is necessary to be divided according to a rule of the AVCHD standard is satisfied as a result of the checking, the creation of a playlist file is determined to be necessary.

Next, the created playlist file is registered in the index file and the movie object file. In other words, the index file (INDEX.BDM) and the movie object file (MOVIEOBJ.BDM) are updated.

Next, each of the stream file of AVCHD and the clip information file made to be a DCF object is renamed with a predetermined file name of the AVCHD standard given with a file number located under a predetermined directory of the standard. Then, each renamed file is transferred to the predetermined directory of the AVCHD standard.

Next, attribute information of a stream file is acquired from the clip information file to be transferred and the acquired attribute information is registered in the playlist file together with a file number.

For example, as shown by arrows 351 and 352 in FIGS. 8A and 8B, a transfer process is performed for each file made to be a DCF object. To be more specific, the transfer process is performed for the file “AVC00001.CPI” 322 and the file “AVC00001.MTS” 323. Then, as shown in FIG. 9A, the file “00000.CPI” 307 is recorded under the directory “CLIPINF” 306, and the file “00000.MTS” 310 is recorded under the directory “STREAM” 309. In the transfer process, attribute information of the stream file is acquired from the file “00000.CPI” 307 to be transferred, and the acquired attribute information is registered in the playlist file “00000.MPL” 305 together with a file number.

In addition, in the same manner, as shown by arrows 353 and 354 in FIGS. 8A and 8B, a transfer process is performed for the file “AVC00001.CPI” 325 and the file “AVC00001.MTS” 326. Then, as shown in FIG. 9A, the file “00001.CPI” 308 is recorded under the directory “CLIPINF” 306, and the file “00001.MTS” 311 is recorded under the directory “STREAM” 309. In addition, registration to the playlist file “00000.MPL” 305 is performed.

The transfer process is repeatedly performed until the transfer process is completed for all DCF objects. In other words, the transfer process is performed as many times as the number of DCF objects. Then, when the transfer process is completed for all the DCF objects, the DCIM directory is deleted. In the deletion, directories and files remaining in the DCIM directory are eliminated together.

In addition, as shown in FIG. 9A, when new content is to be added after the transfer process, each file is recorded under the directory “CLIPINF” 306 and the directory “STREAM” 309 as new content. For example, a file “00002.CPI” 361 and a file “00002.MTS” 362 are recorded.

### [Operation Example of Imaging Device]

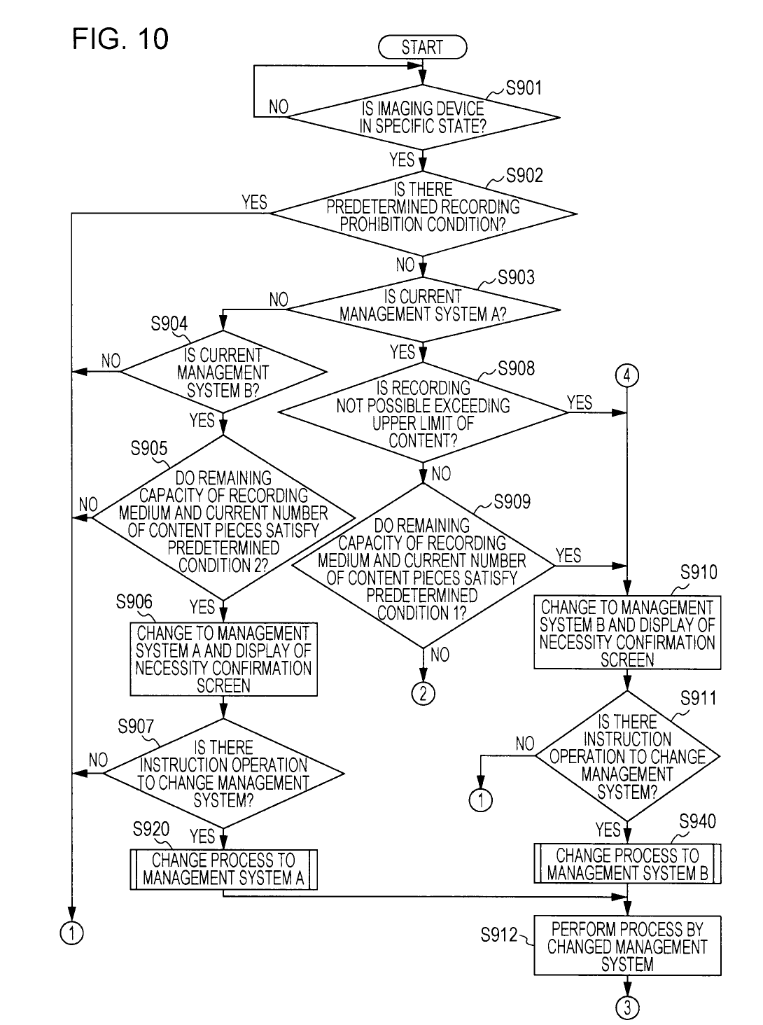

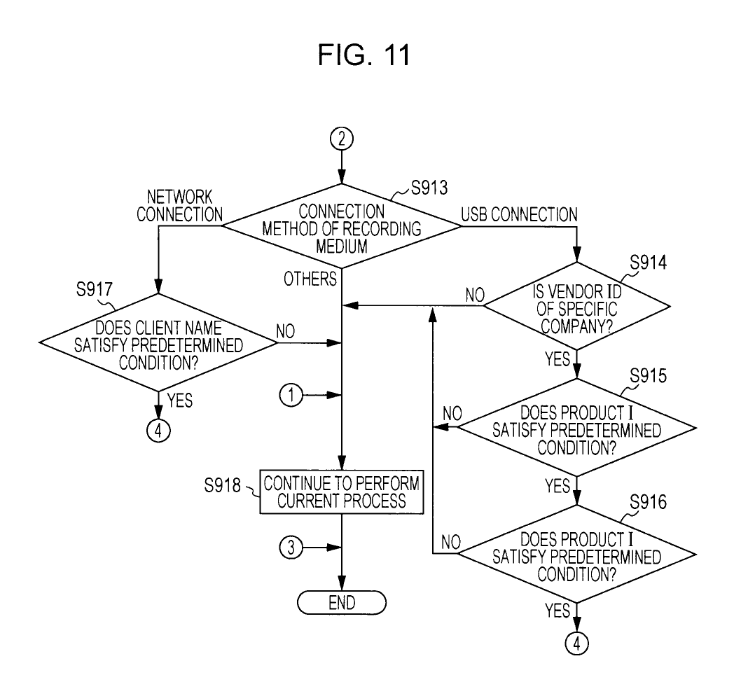

FIGS. 10 and 11 are flowcharts showing an example of a processing procedure of a content management system change process by the imaging device 100 according to the first embodiment of the invention.

At first, it is determined whether or not the imaging device 100 is in a specific state (Step S901). When the imaging device 100 is not in a specific state, monitoring is continued. Such a specific state refers to a state of the device, for example, immediately after recognition completion of the recording medium 200, immediately after electric power start, immediately after transition to a state of preparing an imaging operation (including the end time of the imaging operation), or the like. In addition, for example, a state where content is not able to be additionally recorded in the recording medium 200 can be a specific state. The state where content is not able to be additionally recorded is a state where content is not able to be recorded in the recording medium 200 because, for example, the management system A reaches the upper limit for content when an imaging instruction operation (for example, a moving image capturing instruction operation) is performed. In addition, for example, when an instruction operation for dubbing content is performed, the management system A reaches the upper limit for content, and thus, this is a state where the content to be dubbed is not able to be recorded in the recording medium 200.

When the imaging device 100 is in a specific state, (Step S901), it is determined whether or not a predetermined recording prohibition condition is set (Step S902). The recording prohibition condition is set by, for example, a user's operation. When a predetermined recording prohibition condition is set (Step S902), the current process is continued (Step S918), and the operation of the content management system change process ends. On the other hand, when a predetermined recording prohibition condition is not set (Step S902), it is determined whether or not the current management system is the management system A (Step S903). When the current management system is not the management system A (Step S903), it is determined whether or not the current management system is the management system B (Step S904), and when the current management system is not the management system B, the process advances to Step S918.

In addition, when the current management system is the management system B (Step S904), it is determined whether or not the remaining memory amount of the recording medium 200 and the number of content pieces stored in the recording medium 200 (current number of content pieces) satisfy a predetermined condition 2 (Step S905). For example, the fact that a recordable time for one content piece exceeds 10 minutes for the recordable number of content pieces can be set as the predetermined condition 2.

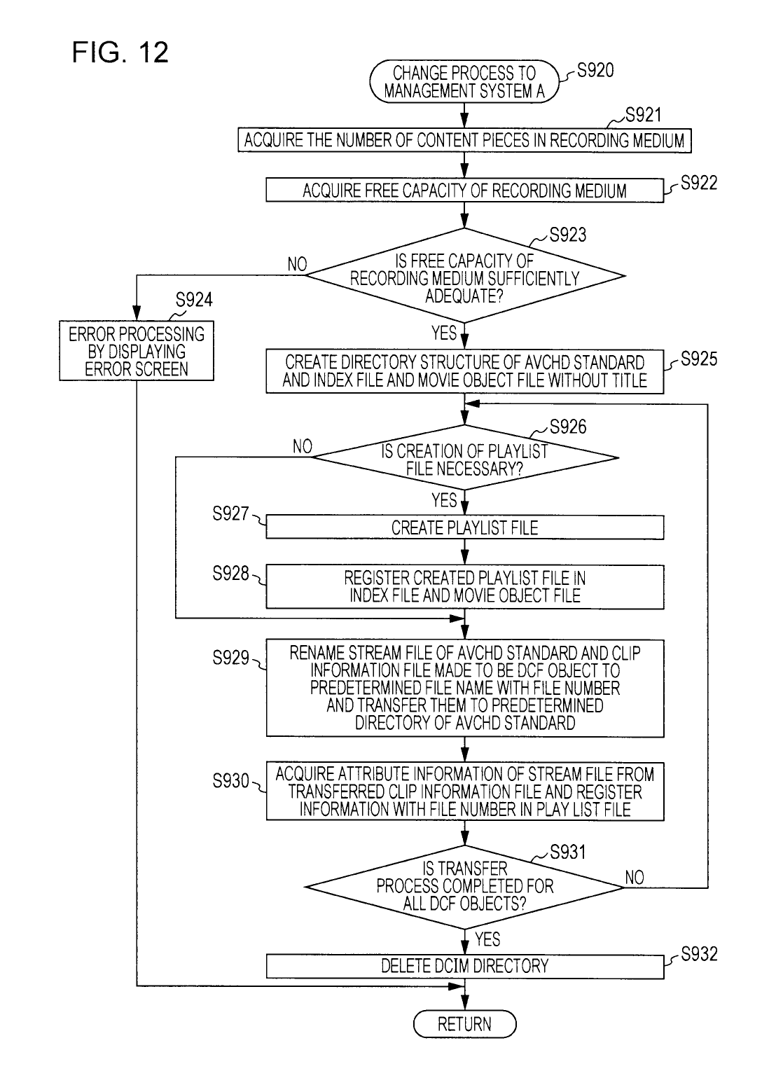

When the remaining memory amount of the recording medium 200 and the current number of content pieces do not satisfy the predetermined condition 2 (Step S905), the process advances to Step S918. On the other hand, when the remaining memory amount of the recording medium 200 and the current number of content pieces satisfy the predetermined condition 2 (Step S905), a change necessity confirmation screen (for example, the change necessity confirmation screen 410 shown in FIG. 5B) for changing to the management system A is displayed on the display unit 180 (Step S906). Next, it is determined whether or not an instruction operation for a management system change (for example, an operation of pressing the “change” button 411) is performed on the change necessity confirmation screen for changing to the management system A (Step S907), and when the instruction operation for a management system change is not performed, the process advances to Step S918. On the other hand, when the instruction operation for a management system change is performed (Step S907), a change process to the management system A is performed (Step S920), and the process advances to Step S912. The change process will be described in detail with reference to FIG. 12.

In addition, when the current management system is the management system A (Step S903), it is determined whether or not the recording medium 200 is not able to record exceeding the upper limit for content (Step S908). When the recording medium 200 is not able to record exceeding the upper limit for content (Step S908), the process advances to Step S910. On the other hand, when the recording medium 200 is able to record exceeding the upper limit for content (Step S908), it is determined that a predetermined condition 1 is satisfied (Step S909). In other words, the remaining memory amount of the recording medium 200 and the number of content pieces (current number of content pieces) stored in the recording medium 200 satisfy the predetermined condition 1 (Step S909). For example, the fact that a recordable time for one content piece exceeds one hour for the recordable number of content pieces can be set as the predetermined condition 1.

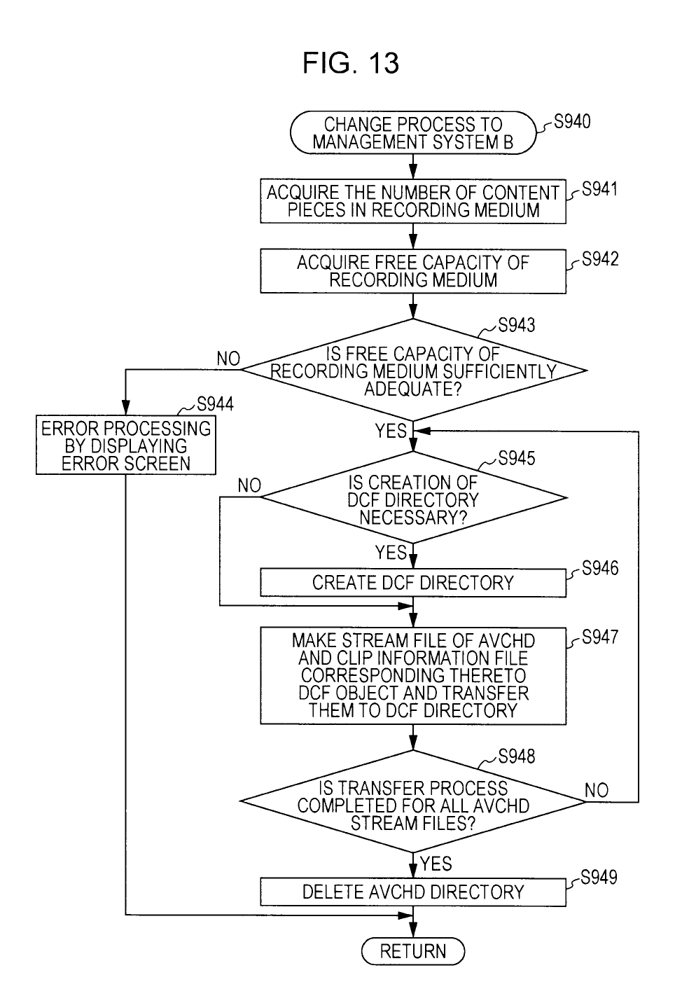

When the remaining memory amount of the recording medium 200 and the current number of content pieces do not satisfy the predetermined condition 1 (Step S909), the process advances to Step S913. On the other hand, when the remaining memory amount of the recording medium 200 and the current number of content pieces satisfy the predetermined condition 1 (Step S909), a change necessity confirmation screen (for example, the change necessity confirmation screen 400 shown in FIG. 5A) for changing to the management system B is displayed on the display unit 180 (Step S910). Next, it is determined whether or not an instruction operation for a management system change (for example, an operation of pressing the “change” button 401) is performed on the change necessity confirmation screen for changing to the management system B (Step S911), and when the instruction operation for a management system change is not performed, the process advances to Step S918. On the other hand, when the instruction operation for a management system change is performed (Step S911), the change process to the management system B is performed (Step S940). The change process will be described in detail with reference to FIG. 13. Subsequently, each process is performed by the management system after the change (Step S912). Furthermore, Steps S920 and S940 are examples of control procedures described in the claims.

In addition, when the remaining memory amount of the recording medium 200 and the current number of content pieces do not satisfy the predetermined condition 1 (Step S909), the connection method between the imaging device 100 and the recording medium 200 is determined (Step S913). When the connection method between the imaging device 100 and the recording medium 200 is USB connection (shown in FIG. 1A) (Step S913), it is determined whether or not the vendor ID (idVendor (producer ID)) of a USB device is of a specific company (Step S914). When the vendor ID of the USB device is of a specific company (for example, Company A) (Step S914), it is determined whether or not the product ID (idProduct (produce ID) of the USB device satisfies a predetermined condition (Step S915). For example, the fact that the product ID of a USB device is “0330h to 033Fh” can be set as a predetermined condition. When the product ID of the USB device satisfies the predetermined condition (Step S915), it is determined whether or not the product I (iProduct (product name)) of the USB device satisfies a predetermined condition (Step S916). For example, the fact that the product I of the USB device is “three leading bytes are CSM (Contents Storage Media)” can be set as a predetermined condition. When the product I of the USB device satisfies the predetermined condition (Step S916), the process returns to Step S910. In other words, when the device is a specific product of a specific company, a change to the management system B can be recommended.

On the other hand, when the vendor ID is not of a specific company (Step S914), when the product ID does not satisfy the predetermined condition (Step S915), and when the product I does not satisfy the predetermined condition (Step S916), the process advances to Step S918.

In addition, when the connection method between the imaging device 100 and the recording medium 200 is network connection (shown in FIG. 1B) (Step S913), it is determined whether or not the client name satisfies a predetermined condition (Step S917). For example, the fact that the client name corresponds to “Photo Server” can be set as a predetermined condition. When the client name satisfies a predetermined condition (Step S917), the process returns to Step S910. When the client name does not satisfy a predetermined condition, the process advances to Step S918. Furthermore, Steps S902 to S905, S907 to S909, S911, and S913 to S917 are examples of determination procedures described in the claims.

Furthermore, a determination process may be performed using only a part of conditions in process procedures shown in this example, and a determination process may be performed using a combination different therefrom.

FIG. 12 is a flowchart showing an example of the change process to the management system A (processing procedure of Step S920 shown in FIG. 10) in the processing procedure of the content management system change process by the imaging device 100 according to the first embodiment of the invention.

At first, the number of content pieces stored in the recording medium 200 is acquired (Step S921), and the free capacity of the recording medium 200 is acquired (Step S922).

Next, it is determined whether or not the free capacity of the recording medium 200 is sufficiently adequate (Step S923). To be more specific, it is determined whether or not there is free capacity sufficient for storing an index file and playlist file of AVCHD. For example, a free capacity of 1 KB for one chapter and a free capacity for several clusters of fixed costs are necessary. When the free capacity of the recording medium 200 is not sufficiently adequate (Step S923), the display unit 180 displays an error screen to perform an error processing (Step S924), and the operation of the change process to the management system A ends.

In addition, when the free capacity of the recording medium 200 is sufficiently adequate (Step S923), the directory structure of the AVCHD standard and an index file and a movie object file without titles are created (Step S925). Next, it is determined whether or not the creation of a playlist file is necessary (Step S926). In other words, the creation of a playlist file is performed depending on the necessity. To be more specific, when a playlist file (MPL) is not present, it is determined that the creation of a playlist file is necessary. On the other hand, when a playlist file is present, attribute information in a clip information file (CPI) is checked. As a result of the checking, if a condition that the playlist file is necessary to be divided according to a rule of the AVCHD standard is satisfied, the creation of a playlist file is determined to be necessary.

When it is not necessary to create a playlist file (Step S926), the process advances to Step S929. On the other hand, when it is necessary to create a playlist file (Step S926), a playlist file is created (Step S927). Next, the created playlist file is registered in the index file and the movie object file (Step S928). In other words, the index file (INDEX.BDM) and the movie object file (MOVIEOBJ.BDM) are updated.

Next, each of the stream file of AVCHD and the clip information file made to be a DCF object is renamed with a predetermined file name of the AVCHD standard given with a file number located under a predetermined directory of the standard. Then, each renamed file is transferred to the predetermined directory of the AVCHD standard (Step S929).

Next, attribute information of the stream file is acquired from the clip information file to be transferred, and the acquired attribute information is registered in the playlist file with the file number (Step S930). Next, it is determined whether or not the transfer process is completed for all the DCF objects (Step S931). In other words, the transfer process from Steps S926 to S930 is repeated as many times as the number of DCF objects. When the transfer process is not completed for all the DCF objects (Step S931), the process returns to Step S926. On the other hand, when the transfer process is completed for all the DCF objects (Step S931), the DCIM directory is deleted (Step S932). In the deletion, directories and files remaining under the DCIM directory are eliminated together. Then, the operation of the change process to the management system A ends.

FIG. 13 is a flowchart showing an example of a change process to the management system B in the processing procedure of the content management system change process (processing procedure of Step S940 shown in FIG. 10) by the imaging device 100 according to the first embodiment of the invention.

At first, the number of content pieces stored in the recording medium 200 is acquired (Step S941), and free capacity of the recording medium 200 is acquired (Step S942).

Next, it is determined whether or not the free capacity of the recording medium 200 is sufficiently adequate (Step S943). To be more specific, it is determined whether or not a capacity also necessary for data size of file entries and directory entries of a file system is sufficient. Generally, the free capacity is determined to be sufficiently adequate in cases of relatively small capacities. When the free capacity of the recording medium 200 is not sufficiently adequate (Step S943), the display unit 180 displays an error screen, an error processing is performed (Step S944), and then the operation of the change process to the management system B ends.

In addition, when the free capacity of the recording medium 200 is sufficiently adequate (Step S943), it is determined whether or not a DCF directory is necessary to be created (Step S945). In other words, the creation of the DCF directory is performed depending on the necessity. To be more specific, cases where a new DCF directory is to be created is when a DCF directory is not present, or when 9999 DCF objects have been recorded in a directory with the highest number of the DCF directory.

When it is not necessary to create a DCF directory (Step S945), the process advances to Step S947, and when it is necessary to create a DCF directory, a DCF directory is created (Step S946). Next, stream files and clip information files of AVCHD corresponding thereto are made to be DCF objects, and each file made to be a DCF object is transferred to the DCF directory (Step S947). In this case, an MTS file and a CPI file are renamed with a DCF file name of the same number and transferred. In other words, the transfer process is performed maintaining the extension without change.

Next, it is determined whether or not the transfer process is completed for all stream files of AVCHD (Step S948). In other words, the transfer process from Step S945 to Step S947 is repeated as many times as the number of stream files of AVCHD. When the transfer process is not completed for all stream files of AVCHD (Step S948), the process returns to Step S945. On the other hand, when the transfer process is completed for all stream files of AVCHD (Step S948), the AVCHD directory is deleted (Step S949). In the deletion, directories and files remaining under the AVCHD directory are eliminated together. Then, the operation of the change process to the management system B ends.

### [Selection Example of Content Management System in Initialization of Recording Medium]

Hereinabove, an example where a content management system is changed by a user's operation when a predetermined condition is satisfied is shown. Herein, in the initialization of the recording medium, a recommended management system is suggested to a user to prompt the execution of medium initialization. Thus, hereinbelow, an example where one is selected from a plurality of management systems in the initialization of a recording medium based on attribute or connection information of a recording medium, and the selected management system is suggested to a user as a recommended management system to prompt the execution of the medium initialization will be shown.

FIG. 14 is a diagram showing an example of an operation screen used when a management system is to be selected in the initialization of a recording medium by the recording control unit 150 according to the first embodiment of the invention. FIG. 14 shows an example of an operation screen (recommended management system notification screen 420) when the management system A is suggested as a recommended management system. The recommended management system notification screen 420 is displayed on the display unit 180 by the display control unit 170 when the recording medium 200 is connected to the imaging device 100 and the initialization operation by a user is performed, or the like.

The recommended management system notification screen 420 includes an “AVCHD” button 421, an “extended AVCHD” button 422, and an “execution” button 423. The “AVCHD” button 421 and the “extended AVCHD” button 422 are buttons to be pressed when the initialization of the recording medium 200 is performed. Herein, a button corresponding to a recommended management system is surrounded by a thick black frame. In addition, explanation of the recommended management system is displayed in a management system description field 424. In the example shown in FIG. 14, the case where the recommended management system is the management system A is shown. In other words, the “AVCHD”button 421 is surrounded by a thick black frame, and explanation of AVCHD is displayed in the management system description field 424.

The “execution” button 423 is a button to be pressed for instructing the execution of the initialization process after any of the “AVCHD” button 421 and the “extended AVCHD” button 422 is pressed. In other words, when either of the “AVCHD” button 421 or the “extended AVCHD” button 422 is pressed, and then the “execution” button 423 is pressed, the initialization process of the selected management system is started.

As such, when a selection operation of a content management system is performed, the control unit 120 outputs a control signal according to the selection operation to the recording control unit 150. When the control signal is received, the recording control unit 150 performs the initialization process of the recording medium 200 according to the received control signal.

Furthermore, this example shows that the display control unit 170 causes the display unit 180 to display the recommended management system notification screen 420 for the initialization of the recording medium 200, a selection operation of a management system is performed by a user, and then the initialization process is performed for the selected management system. However, for example, without performing the selection operation by a user, the initialization process for a recommended management system may be automatically started. In this case, the management system to be initialized can be notified to the user by displaying a notification screen showing the start of the initialization process.

### [Operation Example of Imaging Device]

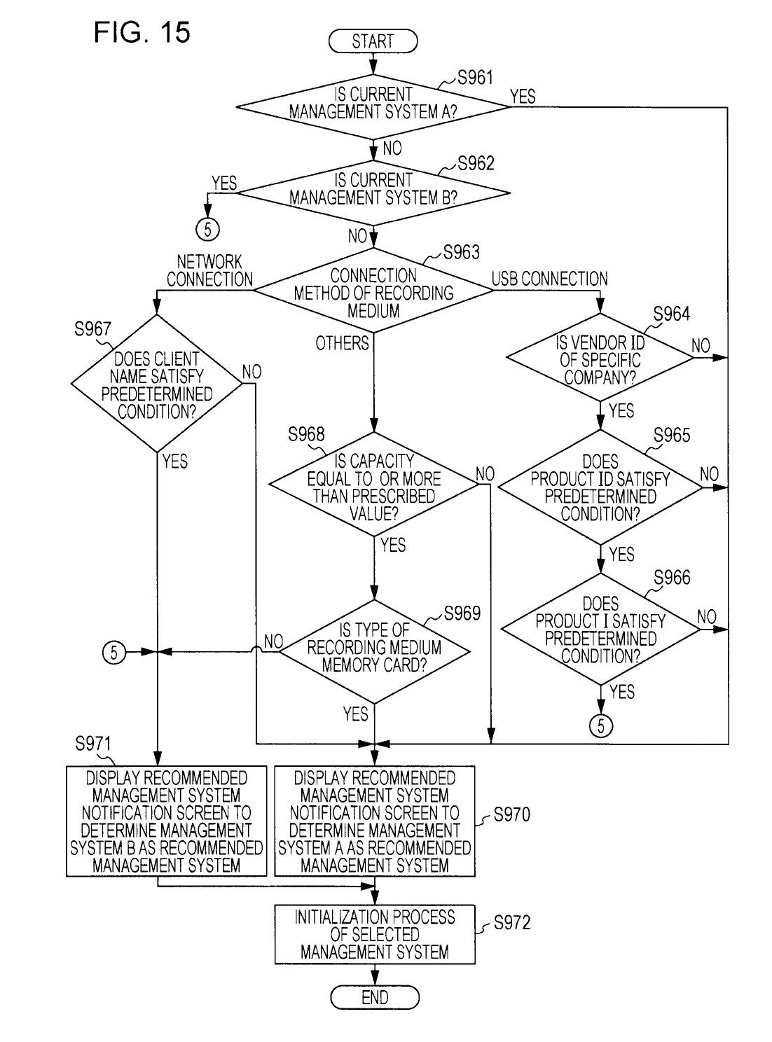

FIG. 15 is a flowchart showing an example of the processing procedure of the initialization process of a content management system by the imaging device 100 according to the first embodiment of the invention.

At first, it is determined whether or not the management system in the recording medium 200 that is the object of the initialization process (current management system) is the management system A (Step S961). When the current management system is the management system A (Step S961), the process advances to Step S970. On the other hand, when the current management system is not the management system A (Step S961), it is determined whether or not the current management system is the management system B (Step S962), and when the current management system is the management system B, the process advances to Step S971.

In addition, when the current management system is not the management system B (Step S962), the connection method between the imaging device 100 and the recording medium 200 is determined (Step S963). When the connection method between the imaging device 100 and the recording medium 200 is USB connection (shown in FIG. 1A) (Step S963), it is determined whether or not the vendor ID (idVendor) of a USB device is of a specific company (Step S964). When the vendor ID of a USB device is of a specific company (Step S964), it is determined whether or not the product ID (idProduct) of the USB device satisfies a predetermined condition (Step S965). When the product ID of the USB device satisfies the predetermined condition (Step S965), it is determined whether or not the product I (iProduct) of the USB device satisfies a predetermined condition (Step S966). When the product I of the USB device satisfies a predetermined condition (Step S966), the process advances to Step S971. Furthermore, those predetermined conditions can be the same as those in the example shown in FIG. 11.

On the other hand, when the vendor ID is not of a specific company (Step S964), when the product ID does not satisfy the predetermined condition (Step S965), and when the product I does not satisfy a predetermined condition (Step S966), the process advances to Step S970.

In addition, when the connection method between the imaging device 100 and the recording medium 200 is network connection (shown in FIG. 1B) (Step S963), it is determined whether or not the client name satisfies a predetermined condition (Step S967). When the client name satisfies a predetermined condition (Step S967), the process advances to Step S971, and when the client name does not satisfy a predetermined condition, the process advances to Step S970. Furthermore, the predetermined conditions can be the same as those in the example shown in FIG. 11.

In addition, when the connection method between the imaging device 100 and the recording medium 200 is neither USB connection nor network connection (Step S963), it is determined whether or not the memory capacity of the recording medium 200 is equal to or greater than a prescribed value (Step S968). When the memory capacity of the recording medium 200 is not equal to or greater than a prescribed value (in other words, when the memory capacity of the recording medium 200 is less than a prescribed value) (Step S968), the process advances to Step S970. On the other hand, when the memory capacity of the recording medium 200 is equal to or greater than a prescribed value (Step S968), it is determined whether or not the type of the recording medium 200 is a memory card (Step S969).

When the type of the recording medium 200 is a memory card (Step S969), a recommended management system notification screen (for example, the recommended management system notification screen 420 shown in FIG. 14) that recommends the management system A for the management system is displayed on the display unit 180 (Step S970). On the other hand, when the type of the recording medium 200 is not a memory card (Step S969), a recommended management system notification screen that recommends the management system B for the management system is displayed on the display unit 180 (Step S971).

Next, the initialization process of the selected management system on the recommended management system notification screen is performed (Step S972), and the operation of the initialization process of the content management system ends.

### 2. Second Embodiment

In the first embodiment of the invention, two content management formats (management system A and management system B) of which the upper limits for the number of manageable content pieces are different from each other are exemplified. In a second embodiment of the invention, two content management formats (management system A and management system B) of which the upper limits for the number of manageable metadata pieces are different from each other will be exemplified. Furthermore, the functional composition of the imaging device in the second embodiment of the invention is substantially the same as that of the example shown in FIG. 2. For this reason, the common portions with the first embodiment of the invention are given with the same reference numerals, and description thereof will be partly omitted. In addition, with regard to the file composition, the common portions with the first embodiment of the invention are given with the same reference numerals, and description thereof will be partly omitted.

### [Data Structure Example and Management System Example of Content Management Format]

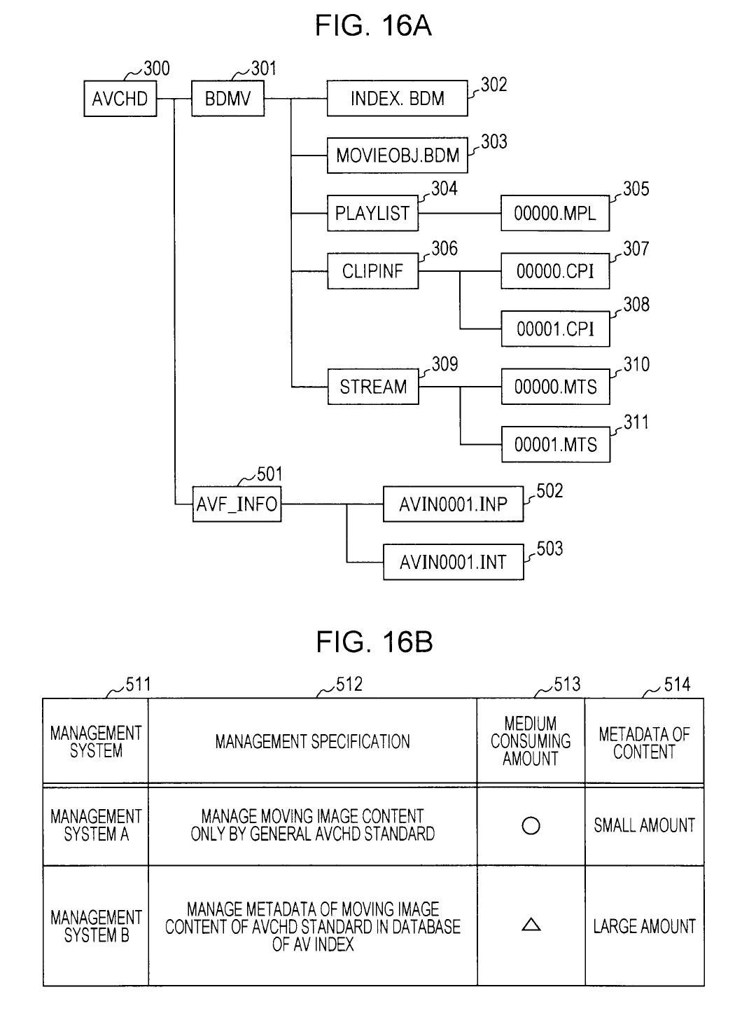

FIGS. 16A and 16B are diagrams showing an example of the file composition and management system of image content stored in the recording medium 200 according to the second embodiment of the invention. Examples of FIGS. 16A and 16B show that image content managed by two content management formats (the management system A and the management system B) of which the upper limits for the number of manageable metadata pieces are different from each other is stored in one recording medium. Furthermore, since the management system A is the same as in the example shown in FIG. 3A, the drawing and description thereof will be omitted here.

FIG. 16A shows an example of the file composition of image content managed by the management system B. FIG. 16B schematically shows management system of content management formats for managing the image content stored in the recording medium 200.

FIG. 16B exemplifies the management system A (shown in FIG. 3A) and the management system B (shown in FIG. 16A) as a management system 511 of a content management format for managing the image content stored in the recording medium 200.

The management system A is a content management format conforming to the AVCHD standard as shown in a management specification 512. In other words, the management system A manages moving image content only by the general AVCHD standard.

The management system B is a content management format for managing metadata of moving image content of the AVCHD standard in a database of the AV index as shown in the management specification 512. Furthermore, the management system A and the management system B can be converted to each other.

In addition, a medium consumption amount 513 is “◯ (small)” for the management system A, but “Δ (relatively large)” for the management system B. In addition, metadata of content 514 is “small” for the management system A, but “large” for the management system B.

As such, as for the management system A, the consuming capacity is small and manageable metadata is small. On the other hand, as for the management system B, the consuming capacity is large, and manageable metadata is large.

For this reason, in the second embodiment of the invention, content and metadata stored in the recording medium 200 are managed by appropriately changing the management system according to the size of the metadata used by a user.

Next, the file composition of image content managed by the management systems A and B will be described. Furthermore, since directories and files arranged under the directory “BDMV” 301 is the same as in the example shown in FIG. 3A, description thereof will be omitted here.

The directory “BDMV” 301 and a directory “AVF_INFO” 501 are arranged under the directory “AVCHD” 300.

The directory “AVF_INFO” 501 is a directory to which files for managing GPS (Global Positioning System) information of chapters, representative thumbnail images, face information (time/arrangement) within chapters and the like belong. For example, when the system is changed to the management system B, a media consumption amount increases by an increment of about several tens KB to 1 MB for one chapter, even though the value is different according to the amount of metadata to be managed.

A file “AVIN0001.1NP” 502 and a file “AVIN0001.1NT” 503 are arranged right under the directory “AVF_INFO” 501.

The file “AVIN0001.1NP” 502 is a UI (User Interface) management information file of the AV stream file, and an attribute registration file of each recorded file.

The file “AVIN0001.1NT” 503 is a UI management information file of the AV stream file, and a file for registering thumbnail images and the like of each recorded file.

### [Operation Example of Imaging Device]

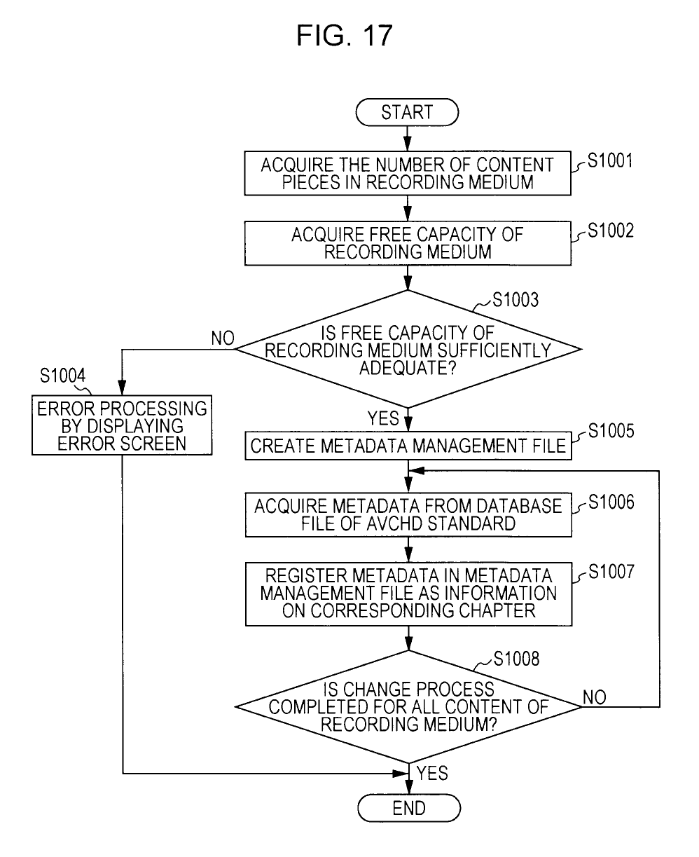

FIG. 17 is a flowchart showing an example of the processing procedure of a content management system change process by the imaging device 100 according to the second embodiment of the invention. The processing procedure is a modified example of FIG. 13, and is a processing procedure of when a change process from the management system A to the management system B is performed. In other words, the example shows a processing procedure after the “change” button is pressed on the change necessity confirmation screen.

At first, the number of content pieces stored in the recording medium 200 is acquired (Step S1001), and free capacity of the recording medium 200 is acquired (Step S1002).

Next, it is determined whether or not the free capacity of the recording medium 200 is sufficiently adequate (Step S1003). To be more specific, it is determined whether or not a capacity for recording a metadata management file in the recording medium 200 is sufficient. For example, 100 KB of free capacity for one content piece is necessary. When the free capacity of the recording medium 200 is not sufficiently adequate (Step S1003), the display unit 180 displays an error screen to perform an error processing (Step S1004), and an operation of a change process to the management system A ends.

In addition, when the free capacity of the recording medium 200 is sufficiently adequate (Step S1003), a metadata management file is created (Step S1005). In other words, an AVF_INFO directory and a database file under the directory are newly created.

Next, metadata is acquired from the database file of the AVCHD standard (Step S1006). For example, metadata (for example, play-back time (duration), or a photographing date information) can be acquired from an MPL file.

Next, the acquired metadata is registered in the metadata management file as information of a corresponding chapter (Step S1007).

Next, it is determined whether or not the change process is completed for all content in the recording medium 200 (Step S1008). In other words, the change process of Steps S1006 and S1007 is repeated as many times as the number of content pieces stored in the recording medium 200. When the change process is not completed for all content in the recording medium 200 (Step S1008), the process returns to Step S1006. On the other hand, when the change process is completed for all content in the recording medium 200 (Step S1008), the operation of the content management system change process ends.

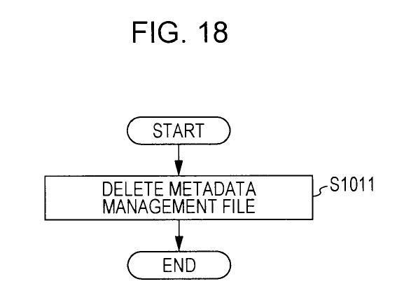

FIG. 18 is a flowchart showing an example of the processing procedure of the content management system change process by the imaging device 100 according to the second embodiment of the invention. The processing procedure is a modified example of FIG. 12, and a processing procedure when a change process from the management system B to the management system A is performed. In other words, the example shows a processing procedure after the “change” button is pressed on the change necessity confirmation screen.

The metadata management file is deleted (Step S1011). In other words, the AVF_INFO directory and the database file under the directory are deleted. Then, the operation of the content management system change process ends.

As such, when the change process from the management system B to the management system A is performed, it is not necessary to register information in a metadata management file of another management system, and therefore, only deletion is sufficient.

### 3. Third Embodiment

A third embodiment of the invention will describe another example of two content management formats (management system A and management system B) of which the upper limits for the number of manageable metadata pieces are different from each other. In addition, the third embodiment of the invention shows an example where the location and the size of a person's face included in an image are used as metadata. Furthermore, the functions and composition of the imaging device in the third embodiment of the invention is substantially the same as those in the example shown in FIG. 2. For this reason, the common portions with those in the first embodiment of the invention are given with the same reference numerals and description thereof will be partly omitted. In addition, the common portions in the file composition with those in the first embodiment of the invention are given with the same reference numerals, and description thereof will be partly omitted.

### [Data Structure Example and Management System Example of Content Management Format]

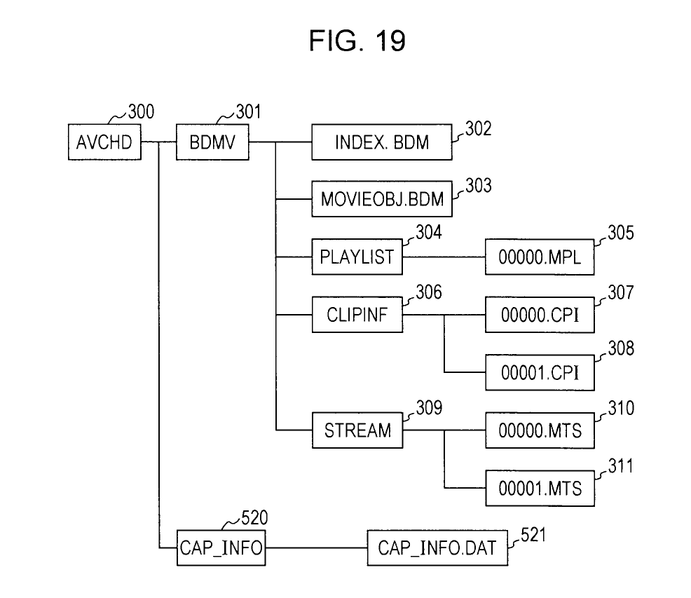

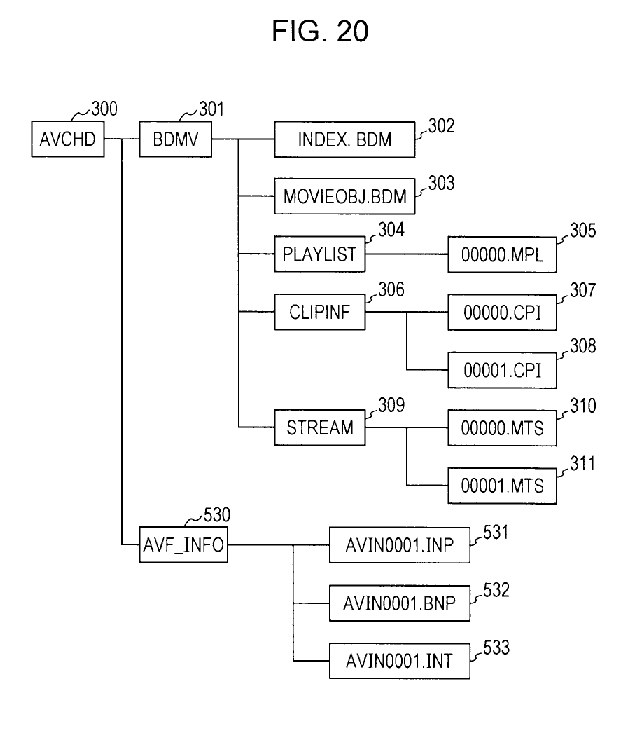

FIGS. 19 to 21 are diagrams showing examples of the file composition and the management system of image content stored in the recording medium 200 according to the third embodiment of the invention. The example shown in FIGS. 19 and 20 shows that image content managed by two content management formats (management system A and management system B) of which the upper limits for the number of manageable metadata pieces is stored in one recording medium.

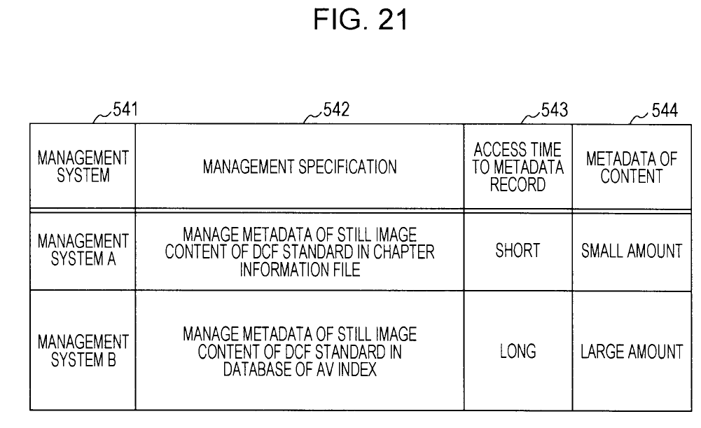

FIG. 19 shows an example of the file composition of image content managed by the management system A. FIG. 20 shows an example of the file composition of image content managed by the management system B. FIG. 21 schematically shows management systems of content management formats for managing image content stored in the recording medium 200.

FIG. 21 exemplifies the management system A (shown in FIG. 19) and the management system B (shown in FIG. 20) as a management system 541 of content management formats for managing image content stored in the recording medium 200.

The management system A is a content management format for managing metadata of still image content of the DCF standard in a chapter information file as shown in a management specification 542.

The management system B is a content management format for managing metadata of still image content of the DCF standard in the database of an AV index as shown in the management specification 542. Furthermore, the management system A and the management system B can be converted to each other.

In addition, a metadata recording access time 543 is “short” for the management system A, but “long” for the management system B. In addition, metadata of content 544 is “small” for the management system A, but “large” for the management system B.

As such, the management system A can perform a high-speed process, but has a small amount of metadata that can be managed. On the other hand, the management system B can perform a high-speed process, but has a large amount of metadata that can be managed.

For this reason, in the third embodiment of the invention, each content and metadata stored in the recording medium 200 are managed by appropriately changing the management system according to the size of the metadata used by a user.

Next, the file composition of the image content managed by the management systems A and B will be described. Furthermore, as directories and files arranged under the directory “BDMV” 301 are the same as those in the example shown in FIG. 3A, description thereof will be omitted.

Under the directory “AVCHD” 300 shown in FIG. 19, the directory “BDMV” 301 and a directory “CAP_INFO” 520 are arranged.

The directory “CAP_INFO” 520 is a directory to which a file for recording the location and the size of a face included in an image as one pair belong. For example, as the location and the size of a face, a location (x, y) and a size (w, h) are recorded by two bytes. As such, since the database of the metadata is small in the management system A, a recording time of the metadata is short, and continuous shooting at a high speed is possible.

Immediately under the directory “CAP_INFO” 520, a file “CAP_INFO.DAT” 521 is arranged. The file “CAP_INFO.DAT” 521 is a file for recording the location and the size of a face included in an image as one pair.

Under the directory “AVCHD” 300 shown in FIG. 20, the directory “BDMV” 301 and a directory “AVF_INFO” 530 are arranged.

The directory “AVF_INFO” 530 is a directory to which files for managing GPS information of chapters, representative thumbnail images, face information (time/arrangement) within chapters, and the like belong.

Immediately under the directory “AVF_INFO” 530, a file “AVIN0001.1NP” 531, a file “AVIN0001.BNP” 532, and a file “AVIN0001.1NT” 533 are arranged.

The file “AVIN0001.BNP” 532 is a UI management information file of the AV stream file, and a back-up file of a file “AVIN****.INP”.

### [Operation Example of Imaging Device]

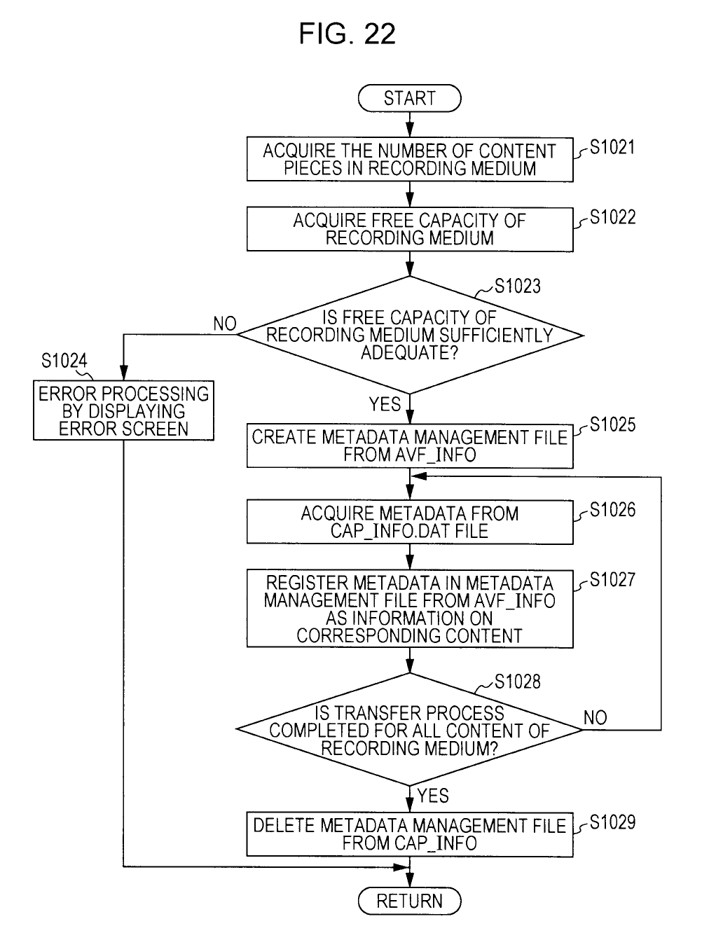

FIG. 22 is a flowchart showing an example of the processing procedure of a content management system change process by the imaging device 100 according to the third embodiment of the invention. This processing procedure is a modified example of FIG. 13, and is a processing procedure when a change process from the management system A to the management system B is performed. In other words, the example shows a processing procedure after the “change” button is pressed on the change necessity confirmation screen.

At first, the number of content pieces stored in the recording medium 200 is acquired (Step S1021), and free capacity of the recording medium 200 is acquired (Step S1022).

Next, it is determined whether or not the free capacity of the recording medium 200 is sufficiently adequate (Step S1023). To be more specific, it is determined whether or not capacity necessary for recording a metadata management file in the recording medium 200 is sufficient. For example, 100 KB of free capacity for one content piece is necessary. As such, since there is a period when both databases exist, the free capacity is checked. When the free capacity of the recording medium 200 is not sufficiently adequate (Step S1023), the display unit 180 displays an error screen to perform an error process (Step S1024), and the operation of the change process to the management system B ends.

In addition, when the free capacity of the recording medium 200 is sufficiently adequate (Step S1023), a metadata management file under AVF_INFO is created (Step S1025). In other words, the AVF_INFO directory and database files under the directory are newly created.

Next, metadata is acquired from the CAP_INFO.DAT file (Step S1026). As the metadata, for example, the location (face location) and the size (face size) of a face are acquired.

Next, the acquired metadata is registered in the metadata management file under the AVF_INFO as information of the corresponding content (Step S1027).

Next, it is determined whether or not the transfer process is completed for all content in the recording medium 200 (Step S1028). In other words, the transfer process of Steps S1026 and S1027 are repeated as many times as the number of content pieces stored in the recording medium 200. When the transfer process is not completed for all content in the recording medium 200 (Step S1028), the process returns to Step S1026. On the other hand, when the transfer process is completed for all content in the recording medium 200 (Step S1028), metadata management files under the CAP_INFO are deleted (Step S1029). In other words, the CAP_INFO directory and database files under the directory are deleted. Then, the operation of the content management system change process ends.

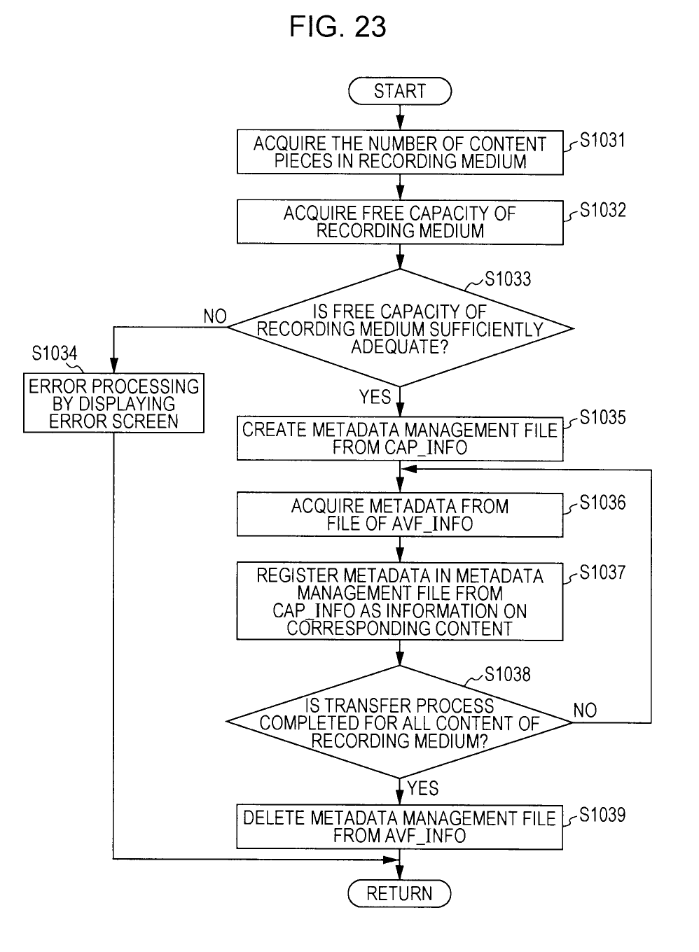

FIG. 23 is a flowchart showing an example of the processing procedure of a content management system change process by the imaging device 100 according to the third embodiment of the invention. This processing procedure is a modified example of FIG. 12, and is a processing procedure when a change process from the management system B to the management system A is performed. In other words, the example shows a processing procedure after the “change” button is pressed on the change necessity confirmation screen.

At first, the number of content pieces stored in the recording medium 200 is acquired (Step S1031), and free capacity of the recording medium 200 is acquired (Step S1032).

Next, it is determined whether or not the free capacity of the recording medium 200 is sufficiently adequate (Step S1033). To be more specific, it is determined whether or not a capacity necessary for recording a metadata management file in the recording medium 200 is sufficient. For example, 100 KB of free capacity for one content piece is necessary. As such, since there is a period when both databases exist, the free capacity is checked. When the free capacity of the recording medium 200 is not sufficiently adequate (Step S1033), the display unit 180 displays an error screen to perform an error process (Step S1034), and the operation of the change process to the management system A ends.

In addition, when the free capacity of the recording medium 200 is sufficiently adequate (Step S1033), a metadata management file under the CAP_INFO is created (Step S1035). In other words, the CAP_INFO directory and the database file under the directory are newly created.

Next, metadata is acquired from files of the AVF_INFO (Step S1036). As the metadata, for example, the location (face location) and the size (face size) of a face are acquired.

Next, the acquired metadata is registered in the metadata management file under the CAP_INFO as information of the corresponding content (Step S1037).

Next, it is determined whether or not the transfer process is completed for all content in the recording medium 200 (Step S1038). In other words, the transfer process of Steps S1036 and S1037 are repeated as many times as the number of content pieces stored in the recording medium 200. When the transfer process is not completed for all content in the recording medium 200 (Step S1038), the process returns to Step S1036. On the other hand, when the transfer process is completed for all content in the recording medium 200 (Step S1038), metadata management files under the AVF_INFO are deleted (Step S1039). In other words, the AVF_INFO directory and database files under the directory are deleted. Then, the operation of the content management system change process ends.

As such, in the second and third embodiment of the invention, when a content management format is changed, the control unit 120 controls the transfer process of attribute information on actual data files. In other words, the control unit 120 controls the transfer process of attribute information on actual data files so that the attribute information among content managed by a content management format before a change is managed by another recording format.

As shown herein above, according to the embodiments of the invention, when a plurality of content management formats is present, it is possible to use a recording medium effectively according to different characteristics. For example, media have been increasing in capacity and applications that deal with such media have been diversifying in recent years. For this reason, it is possible to use media effectively according to the characteristics of each management format by easily switching a content management format according to conditions such as capacity and the number of content pieces to be managed, even for the same type of media. In addition, of example, when a back-up process is performed using a large-capacity storage, it is possible to perform back-up to the full extent of the large-capacity storage without being mindful of the upper limit for the content pieces. As such, according to the embodiments of the invention, when a plurality of management systems is present, it is possible to easily switch the system to an appropriate management system.

Furthermore, the embodiments of the invention show an example to realize the invention, and as described in the embodiments of the invention, the subjects of the embodiments and invention-specific subjects in the claims thereof have corresponding relationships with each. In the same manner, the invention-specific subjects in the claims and the subjects in the embodiments given with the same names as those have corresponding relationships with each. However, the invention is not limited to the embodiments, and can be realized by performing various modifications to the embodiments within a range not departing from the gist of the invention.

In addition, the processing procedures described in the embodiments may be understood as methods having such a series of procedures, and may be understood as a program that causes a computer to execute the series of procedures or a recording medium that stores the program. As such a recording medium, for example, CDs (Compact Discs), MDs (MiniDiscs), DVDs (Digital Versatile Discs), memory cards, Blu-ray Discs (registered trademark), or the like can be used.

The present application contains subject matter related to that disclosed in Japanese Priority Patent Application JP 2010-137793 filed in the Japan Patent Office on Jun. 17, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a content management unit which manages a plurality of content pieces stored in a recording medium in any of a plurality of recording formats; and
a control unit that controls to change a recording format of each content piece to be managed so that each content piece is managed in a recording format other than a recording format that manages each content piece stored in the recording medium when a specific operation is performed or when a given condition is satisfied.

2. The information processing apparatus according to claim 1,
wherein the given condition is a condition specified by the relationship between information regarding a recording capacity of the recording medium and the number of a plurality of content pieces that are the recording target of the recording medium, and
wherein the control unit controls the changes so that each content piece is managed in a specific recording format when the relationship between information regarding a recording capacity of the recording medium and the number of a plurality of content pieces that are the recording target of the recording medium satisfies the given condition.

3. The information processing apparatus according to claim 2,
wherein the plurality of recording formats is recording formats of which the upper limits for content to be managed are different from each other,
wherein the specific recording format is a recording format of which compatibility regarding play-back using devices other than the information processing apparatus is low, and which has a larger number of content pieces to be managed than has another recording format, and
wherein the recording format other than the specific recording format is a recording format of which compatibility regarding play-back using devices other than the information processing apparatus is high, and which has a smaller number of content pieces to be managed than has the specific recording format.

4. The information processing apparatus according to claim 1, further comprising:
an interface for connecting the recording medium,
wherein the given condition is a condition specified by a connection method of the recording medium via the interface, and
wherein the control unit controls to perform the change so that each content piece is managed in a specific recording format when the connection method of the recording medium via the interface satisfies the given condition.

5. The information processing apparatus according to claim 1, wherein when a recording format of each content piece to be managed is changed, the control unit controls such that an actual data file and attribute information regarding the actual data file among content managed in the recording format before the change are paired, and the pair of the actual data file and the attribute information is subjected to a transfer process so as to manage the pair of the actual data file and the attribute information in the other recording format.

6. The information processing apparatus according to claim 1, wherein, when a recording format of each content piece to be managed is changed, the control unit controls to perform a transfer process of attribute information regarding an actual data file among content managed by the recording format before the change so that the attribute information is managed in the other recording format.

7. The information processing apparatus according to claim 1, wherein the content management unit manages content added after the change is performed in the other recording format.

8. An information processing apparatus comprising:
an interface for connecting a recording medium;
a content management unit that manages a plurality of content pieces stored in the recording medium in any of a plurality of recording formats; and
a control unit that controls to perform an initialization process by determining a recording format of each content piece to be managed so that each content piece stored in the recording medium is managed in a specific recording format when a connection method of the recording medium via the interface satisfies a given condition.

9. An information processing method comprising the steps of:
determining whether or not a specific operation is performed or a given condition is satisfied; and
controlling to change a recording format of each content piece to be managed so that each content piece is managed in a recording format other than a recording format that manages each content piece stored in the recording medium when the specific operation is performed or when the given condition is satisfied.

10. A program that causes a computer to execute:
determination whether or not a specific operation is performed or a given condition is satisfied; and
control to change a recording format of each content piece to be managed so that each content piece is managed in a recording format other than a recording format that manages each content piece stored in the recording medium when the specific operation is performed or when the given condition is satisfied.
